(19) United States
(12) Patent Application Publication
(10) Pub. No.: US 2004/0259063 A1
(43) Pub. Date: Dec. 23, 2004

(54) Method and apparatus for training employees and managers to improve interpersonal relationships

(76) Inventor: Michael J. Lehr, Akron, OH (US)

Correspondence Address: BROUSE MCDOWELL, INTELLECTUAL PROPERTY GROUP, 500 FIRST NATIONAL TOWER, AKRON, OH, 44308, US

(21) Appl. No.: 10/695,023

(22) Filed: Oct. 28, 2003

Related U.S. Application Data
(60) Provisional application No. 60/479,794, filed on Jun. 19, 2003.

(51) Int. Cl. G09B 19/00

(52) U.S. Cl. 434/236; 434/219

(57) ABSTRACT

A method for training employees and other personnel to aid the improvement of interpersonal relationships is herein described. The inventive method utilizes the compilation and interrelation of allegories with audience questions and comments to direct the audience down the path of better understanding and appreciation for interpersonal relationships.

### I. BACKGROUND OF THE INVENTION

A. Field of Invention

This application claims priority to U.S. Provisional Application No. 60,479,794, filed on Jun. 19, 2003. This invention pertains to the art of training methods, and more particularly to methods for helping people have more effective interpersonal relationships, and even more particularly to utilizing allegories and audience participation to help people have more effective interpersonal relationships.

B. Description of the Related Art

It is known to provide training sessions for employees, and others, to help them in their dealings with other people. In particular, these training sessions are typically used to train employees in sales, service, and communication techniques while including managerial techniques for managers and employers. These seminars are typically in a scientific format, where the instructor introduces a topic or technique, or a collection of topics and techniques, runs through its logic, presents the evidence supporting it, outlines its details or steps, facilitates its discussion, and organizes its practice for the purpose of encouraging the audience to adopt specific behaviors resulting from the topic or technique. Typically, a handout is presented before the seminar begins, outlining the main topics or techniques that the instructor is going to cover, and what conclusion the instructor is trying to reach.

It is known in these training sessions that instructors employ techniques to deliver the topic or technique, its evidence, details or steps, discussion, and practice within a scientific format. Typically, one technique employs the use of stories as a way to introduce the training session, present evidence, demonstrate examples of details or steps, facilitate discussion, and frame practice. These stories can either be fictional or non-fictional and based on any number of facts; however, these facts may or may not qualify as evidence supporting the topic or technique because their legitimacy may be in question. Typically, fictional stories in the form of case studies are used to show examples of the details within a topic, or of the steps within a technique, or used to facilitate practice. In this way, stories facilitate the understanding and adoption of the topic or technique and are known to encourage acceptance even though they may not be evidence.

It is known in the employment of stories that they need not have an obvious, immediate, or direct connection to the topic or technique. Typically, in this case, they serve a symbolic purpose and are often well-known movies, songs, stories, or books. Twelve O'Clock High is a known movie that serves a symbolic purpose, beyond its obvious, immediate, and direct story, of a group of American men in the air force during World War II, by displaying the interaction of various personality types and examples of organizational behavior.

It is known in these training sessions that instructors employ symbols to represent the topic, technique, details, steps, or other aspects. Typically, words or pictures will serve as symbols to represent a collection of techniques, details, steps, or aspects. These words or pictures may have an obvious, immediate, or direct meaning in everyday life but will come to have a more involved, indirect meaning when used within a particular field, endeavor, or situation. In the business of football, short statements expressed as plays represent complex interactions which would require immense time to communicate without that short statement. Likewise, in business, short statements expressed symbolically through words or pictures become symbols of complex business interactions.

It is known in the employment of symbols that one symbol may be more favored than another even though both symbolize the same thing. There is an emotional aspect to symbols that instructors consider in their choice of words or pictures to symbolize an aspect of their topic or technique, because their choice can affect acceptance. Typically, instructors know the difference in emotional impact something can deliver if the choice between symbols is the American flag or the Swastika.

It is known that symbols are unscientific because they do not necessarily represent the same thing to every person, and they may represent things that are not totally known, understood, or defined. Typically, they are not offered as evidence because they lack a logical connection to the things they represent because the connection is not obvious, immediate, or direct. As is known, the expression of a symbol in words is difficult because the symbol typically seeks to express singularly what many words attempt to convey.

None of the available seminars or training methods utilizes an unscientific method in which a database of allegories aid people in better evaluating, better understanding, better appreciating, and better employing their interpersonal relationships. This enhancement of interpersonal relationships will help people do their jobs, and live their lives, better and will translate into better financial outcomes for the business than otherwise would have been achieved.

This invention addresses four business challenges. The first, and one of the biggest, is effective communication. Employees need to help their customers and each other while managers need to help employees. In all of these, the quality of communication affects the successful employment of this help. The present invention will aid businesses, as well as other individuals, in communicating effectively to enhance their interpersonal relationships. With better communications among employees and managers regarding the growth of the business and helping clients, and with a better understanding and appreciation for how to communicate with clients, businesses will enhance their communication with their customers, which will then, in turn, produce a better relationship with the customer. Better relationships with customers generally mean better sales and expenses, which yield better profits.

The statement “attitude is everything” implies a second business challenge this invention addresses: the better development of an affinity for one's work. Generally, employees who like their work will tend to do their jobs better than those who do not. As employees do better at their work this increases the likelihood that the business will do better financially. An aspect of their job is relating to others in various roles. Having improved affinities for their jobs will increase the likelihood that they will better use techniques for enhancing their interpersonal relationships. Jobs are becoming increasingly specialized with the passage of time, so the holistic incorporation of all the talents one has is diminishing. Consequently, relating the importance of one's job to the entire business, the world, and oneself is increasingly difficult because its scope is becoming increasingly narrow. People's attitudes affect their success because they drive how people interpret the factors impacting their work.

A third challenge this invention addresses is encouraging action on the concepts and techniques designed to improve interpersonal skills by increasing the likelihood this will happen and decreasing the necessity for financial incentives. With the acquisition of any new skill there is initial hesitancy in the use of it that manifests itself in various rationalizations; however, they all stem in various degrees from the fear of humiliation. This arises when people use a technique that they fear will cause them to seem foolish or incompetent regardless of whether this fear is consciously recognized. Many times this fear is rationalized by saying the technique is useless, time consuming, or inadequately taught. Often businesses must spend money on financial incentives to encourage the adoption of new things. By encouraging people to take action on what they learn by overcoming their initial hesitancy, people will more likely be successful in employing various concepts and techniques to improve their interpersonal relationships at potentially lower cost to the company. By improving their interpersonal relationships, employees will be more likely to help the business succeed financially. The less likely employees are to implement new concepts and techniques, the less likely businesses will derive the benefits they expect from training, regardless of how well employees may understand the concepts and techniques. Thus, encouraging employees to employ new concepts and techniques is financially important to a business.

The fourth challenge this invention addresses is the need to improve conditions under which businesses facilitate future training. The underpinnings of the techniques to improve interpersonal relationships involve many complex sociological and psychological forces. While it may be easy to convey a technique, the concept behind why it works is often extremely involved and difficult to communicate; however, if people are to effectively use these techniques to address all the nuances that may arise in their individual situations, they will need to understand and appreciate the concepts behind them. If people are to improve their communications with others, their affinities for their work, and their likelihood to take actions, then people will need to have simple ways to express complex, interpersonal concepts that will allow them to grow their interpersonal relationships beyond what they initially accomplished in the seminar. Managers will often drive much of this development through various coaching techniques. They will need to have ways to communicate and build upon complex interpersonal concepts that will save them time and make them more effective. By giving managers and employees a way to do this, businesses will be in a better position to not only realize the benefits from the seminar but also to build upon them individually with their people.

### II. SUMMARY OF THE INVENTION

In accordance with one aspect of the present invention, an unscientific method using allegories for training individuals to have more effective relationships includes the steps of providing at least two allegories, the allegories designed to make a point about interpersonal relationships; asking a series of questions to an associated audience, receiving answers to the series of questions; choosing a first allegory based upon the answers to the series of questions; relating the first allegory to the associated audience, continuing to ask questions during the relating of the first allegory, allowing comments and questions from the audience during relating of the first allegory; choosing at least a second allegory based upon the answers to the series of questions and the comments from the audience during the relating of the first allegory; allowing comments and questions from the audience during the relating of the at least a second allegory; interrelating the allegories based upon the answers, the questions, and the comments; and utilizing the allegories and their interrelation to progress from one idea to a final conclusion.

In accordance with another aspect of the present invention, an unscientific method for training employees to develop better interpersonal skills includes the steps of providing a collection of allegories, each of the allegories having a message relating to interpersonal relationships; providing a set of assumptions; asking a series of questions of an associated audience, the questions designed to determine the starting point of the method; receiving answers to the series of questions; relating assumptions to the associated audience, the amount of time spent discussing the assumptions dependent upon the answers to the series of questions; choosing a first allegory from the collection of allegories based upon the answers to the series of questions and the set of assumptions; relating the first allegory to the associated audience, allowing questions from the associated audience during the relating of the first allegory; determining the amount of time spent relating the allegory by the questions and comments from the associated audience during the relating of the first allegory, choosing a second allegory based upon the answers to the series of questions, the comments from the audience during the relating of the first allegory, and the interrelation of the two allegories; relating the second allegory to the associated audience, allowing comments and questions from the audience during the relating of the second allegory; interrelating the allegories based upon the answers and the comments; choosing at least a third allegory based upon the answers to the series of questions and the comments from the audience during the relating of the first and second allegories; allowing comments from the audience during the relating of the at least a third allegory; interrelating the allegories based upon the answers and the comments; utilizing the allegories to progress from a first idea to at least an incrementally different second idea; and utilizing the allegories and their interrelation to progress from the first idea to a final idea.

In accordance with another aspect of the present invention, the method further includes utilizing the at least three allegories in progressive incremental steps.

In accordance with another aspect of the present invention, the method further includes choosing at least a final allegory based upon the answers to the series of questions and the comments from the audience during the relating of all previous allegories, allowing comments from the audience during the relating of the final allegory, interrelating all of the allegories based upon the answers and the comments, and utilizing all of the allegories and their interrelation to progress from one idea to the final idea, wherein the difference between the point of the final allegory and the point of the first allegory is larger than the difference between the point of the first allegory and the point of the second allegory.

In accordance with another aspect of the present invention, the method further includes selecting a final idea to be reached prior to selecting the first allegory.

In accordance with another aspect of the present invention, the allegories are presented via an electronic medium.

In accordance with another aspect of the present invention, a computer readable medium containing instructions for controlling a computer system to perform a method including providing a database of allegories, each of the allegories having a message relating to interpersonal relationships; providing a set of assumptions; asking a series of questions of an associated audience, the questions designed to determine the starting point of the method; receiving answers to the series of questions; relating assumptions to the associated audience, the amount of time spent discussing the assumption dependent upon the answers to the series of questions; choosing a first allegory from the database of allegories based upon the answers to the series of questions and the set of assumptions; relating the first allegory to the associated audience, allowing questions from the associated audience during the relating of the first allegory, determining the amount of time spent relating the allegory by the questions from the associated audience during the relating of the first allegory; choosing a second allegory based upon the answers to the series of questions, the comments from the audience during the relating of the first allegory, and the interrelation of the two allegories; relating the second allegory to the associated audience, allowing comments from the audience during the relating of the second allegory; interrelating the allegories based upon the answers and the comments; choosing at least a third allegory based upon the answers to the series of questions and the comments from the audience during the relating of the first and second allegories; relating the third allegory to the associated audience, allowing comments from the audience during the relating of the at least a third allegory; interrelating the allegories based upon the answers and the comments; utilizing the allegories to progress from a first idea to at least an incrementally different second idea; and utilizing the allegories and their interrelation to progress from the first idea to a final idea.

In accordance with another aspect of the present invention, the computer readable medium further includes utilizing the at least three allegories in progressive incremental steps.

In accordance with another aspect of the present invention, the computer further includes choosing at least a final allegory based upon the answers to the series of questions and the comments from the audience during the relating of all previous allegories, allowing comments from the audience during the relating of the final allegory; interrelating all of the allegories based upon the answers and the comments; and utilizing all of the allegories and their interrelation to progress from one idea to the final idea, wherein the difference between the point of the final allegory and the point of the first allegory is larger than the difference between the point of the first allegory and the point of the second allegory.

In accordance with another aspect of the present invention, the computer readable medium further includes selecting a final idea to be reached prior to selecting the first allegory.

In accordance with another aspect of the present invention, the allegories are presented via an electronic medium.

Still other benefits and advantages of the invention will become apparent to those skilled in the art to which it pertains upon a reading and understanding of the following detailed specification.

III. Definitions

To assist the reader in understanding the description of this invention, the definitions of the following terms should be noted.

Allegory—a story, song, movie, diagram, poem, image, picture, or the like in which the meaning is symbolically expressed through fictional figures and actions, words, diagrams, pictures, or symbols regarding truth or generalizations about a practice, belief, human behavior, or natural phenomenon; a symbolic story in which it is composed of symbols or is itself symbolic.

Archetype—an original image inherited at birth common to all humans that emerges as a symbol in various forms to represent an emotion or intuition for a collection of emotions and to encourage certain actions.

Authority—a persuasive influence based on knowledge, expertise, or legitimacy.

Cognition—the act or process of knowing based upon mental processes involving such things as sense, memory, judgment, reasoning, and logic.

Database—any compilation of information.

Evidence—legitimate fact or group of facts indicating whether or not a thing is true or valid.

Fact—a thing that is known to have occurred, to exist, or to be true.

First Party (Primary)—that which is associated with a member or members of the audience.

Intuition—the direct perception of something independent of mental processes; immediate apprehension through emotions.

Legitimate—in accordance with formally or informally established rules, principles, standards, methods, precedents, laws of reasoning, or research.

Logic—the interrelation or sequence of facts or events when seen as inevitable or predictable that allow for correct or reliable inferences.

Research—the systematic logical inquiry into and study of materials, sources, and authorities in order to discover, reinforce, or revise established facts, theories, applications, or conclusions.

Scientific—supported by using the scientific method or by comments, statements, or writings, not limited to science, submitted as evidence from authoritative secondary and tertiary sources.

Scientific Method—legitimate principles and procedures, not limited to science, for the systematic, logical pursuit of knowledge involving the recognition and formulation of a condition, the collection of relevant data through observation, experiment, or research, the formulation of a hypothesis from these data, and the testing of that hypothesis to arrive at a conclusion about the validity of the hypothesis.

Second Party (Secondary)—that which is associated with the presenter.

Story—a fictional or non-fictional account of incidents, facts, experiences, pictures, expressions, symbols, or events.

Symbol—a thing that implies something more than its obvious, immediate, and direct meaning and comes to typify, represent, or recall something regardless of whether that something is totally known, understood, or defined.

Third Party (Tertiary)—that which is associated with someone other than the audience or presenter.

Unscientific—not supported scientifically.

### III. BRIEF DESCRIPTION OF THE DRAWINGS

The invention may take physical form in certain parts and arrangement of parts, at least one embodiment of which will be described in detail in this specification and illustrated in the accompanying drawings which form a part hereof and wherein:

FIG. 1 is the first six pictures in the first representative allegory;

FIG. 2 is the second six pictures in the first representative allegory;

FIG. 3 is the third six pictures in the first representative allegory;

FIG. 4 is the fourth six pictures in the first representative allegory;

FIG. 5 is the fifth six pictures in the first representative allegory;

FIG. 6 is the sixth six pictures in the first representative allegory;

FIG. 7 is the seventh six pictures in the first representative allegory;

FIG. 8 is the final two pictures in the first representative allegory;

FIG. 9 is the first six pictures in the second representative allegory.

FIG. 10 is the second six pictures in the second representative allegory;

FIG. 11 is the third six pictures in the second representative allegory;

FIG. 12 is the fourth six pictures in the second representative allegory;

FIG. 13 is the fifth six pictures in the second representative allegory;

FIG. 14 is the sixth six pictures in the second representative allegory;

FIG. 15 is the seventh six pictures in the second representative allegory;

FIG. 16 is the final five pictures in the second representative allegory;

FIG. 17 is the first example of a diagrammatic allegory;

FIG. 18 is a continuation of the first diagrammatic allegory of FIG. 17;

FIG. 19 is a continuation of the first diagrammatic allegory of FIG. 18;

FIG. 20 is a continuation of the first diagrammatic allegory of FIG. 19; and,

FIG. 21 is the completion of the first diagrammatic allegory.

FIG. 22 is the second example of a diagrammatic allegory;

FIG. 23 is a continuation of the second diagrammatic allegory of FIG. 22;

FIG. 24 is a continuation of the second diagrammatic allegory of FIG. 23;

FIG. 25 is a continuation of the second diagrammatic allegory of FIG. 24;

FIG. 26 is a continuation of the second diagrammatic allegory of FIG. 25;

FIG. 27 is a continuation of the second diagrammatic allegory of FIG. 26;

FIG. 28 is a continuation of the second diagrammatic allegory of FIG. 27;

FIG. 29 is a continuation of the second diagrammatic allegory of FIG. 28;

FIG. 30 is a continuation of the second diagrammatic allegory of FIG. 29;

FIG. 31 is a continuation of the second diagrammatic allegory of FIG. 30;

FIG. 32 is a continuation of the second diagrammatic allegory of FIG. 31;

FIG. 33 is a continuation of the second diagrammatic allegory of FIG. 32;

FIG. 34 is a continuation of the second diagrammatic allegory of FIG. 33;

FIG. 35 is a continuation of the second diagrammatic allegory of FIG. 34;

FIG. 36 is a continuation of the second diagrammatic allegory of FIG. 35; and,

FIG. 37 is the completion of the second diagrammatic allegory.

### IV. DETAILED DESCRIPTION OF THE INVENTION

There is provided an unscientific method based upon the use of allegories for enabling individuals to have more effective interpersonal relationships by improving communication with others, an affinity for one's work, the encouragement for action, and conditions for future training. In the present invention, certain assumptions are made which are helpful for understanding the process described herein. The following assumptions will be taken to be true throughout this process (it is to be understood, however, that the list of assumptions is not intended to be exhaustive, and is not intended to be a requirement for this invention): 1) emotions are more powerful than thoughts and consequently more influential; 2) people are more influenced, motivated, and inspired by things they like than things they understand; 3) intuition is a collection of feelings or emotions about something ; 4) intuition about something is more comprehensive than knowledge of the same thing; 5) people will feel things before they are conscious of those feelings; 6) people will consciously feel something before they can form those feelings into thoughts; 7) personal observations are more influential than second and third party comments; 8) many times people are not aware of the things influencing them; 9) even though people are aware of something, it can influence them without their knowledge; 10) people aware of an influence may incorrectly attribute it to something else if at all; 11) people's likes influence them despite the absence of reasons for liking or influence; 12) imaginary things can influence people; 13) placing things in groups alters the influence that each thing delivered individually; 14) groups of things influence people despite the absence of a rational connection among the things; 15) rearranging a group of things will cause the same group to exert a different influence; 16) people are born with varying emotional capabilities and thus varying intuitive capabilities too; 17) people can develop their intuition as they can develop their minds and muscles; 18) intuition, as with minds and muscles, atrophy with disuse; 19) symbols and archetypes can encourage certain feelings and intuitions; 20) one can establish a method to influence people using things they like and have empirically observed even though these things are unsupported or determined unrealistic by the scientific method or second and third parties.

One of the objects of the present invention is to tap into the power of the premise that people are more influenced, motivated, and inspired by things they like than things they understand. For instance, someone may not totally understand how a car works, but this does not prevent him from wanting a car; his emotional affinity for the car is more likely to influence his purchase of it than his understanding of it.

A scientific training method seeks to offer concepts and techniques that are supportable by evidence demonstrating their effectiveness. Unless a fact is considered evidence, it cannot support a concept's or technique's effectiveness. Usually facts that are not evidential are considered unique to the person or persons experiencing that fact. In a court of law, we generally refer to these as “hearsay,” “speculation,” or “inadmissible,” while more commonly we refer to them as “unsubstantiated” or “unproven.” Evidence is considered independent of the opinions and feelings of the one offering it. We use “objective” to describe this independent perspective that is uniform to all. The purpose of this evidence in training is to have the audience understand and accept the reasons why it's important that they adopt the concepts or techniques.

On the other hand, an unscientific training method accepts virtually any facts in making the case for its concepts and techniques. The most important facts in this method and the ones most emphasized are first-party ones, (i.e. ones from the audience), which generally are considered unscientific facts. Unless the person in the audience is an authority, generally unscientific facts are considered non-evidential in scientific training. Many facts in unscientific training may only be particular to a person in the audience and thus not experienced by another. An important way non-evidential facts differ from evidence is their variability according to the perspective of the person citing them. The same facts accepted as evidence in scientific training could vary in unscientific training depending upon the first party's perspective. In this way, they are dependent upon the subject, the one presenting the fact; thus, non-evidential facts are often considered “subjective,” something based upon the opinion or feelings of the first party.

The distinction between these two training methods is important to our original statement, “people are more influenced, motivated, and inspired by things they like than things they understand,” because the emotional element necessitated by liking something is far more prevalent in the unscientific training method than the scientific one. By its very nature a scientific approach to any topic is inherently emotionless to preserve objectivity. The quality control aspects that insure that subjectivity or emotion does not taint evidence are the employment of regimens such as the scientific method, research, and logic and the reliance on experts qualified as authorities on a concept or technique. These aspects manifest themselves in the form of rules, regulations, procedures, codes, principles, credentials, background, degrees, experience, and many others. Thus, not just anyone can say whatever he feels and have it accepted as evidence. In unscientific training, what someone feels is more important than evidence no matter how much it may contradict that evidence.

A second object of this invention is to tap into the common emotions that link us as human beings. Even though a subjective, unscientific approach emphasizes the individual perspectives of the first party and thus gives rise to the problem of attempting to work with as many perspectives as there are audience members, there are common emotions to all human beings. Our inherent emotions are not randomly determined on an individual basis. Sometimes these emotions are triggered by common experiences. In both emotions and experiences, it is important that we look at “common” to mean something closer to “similar” than “exactly the same.”

A third object of this invention is to realize the advantage of symbolic meanings over definitional meanings in the expression of feelings as typified by the statement, “a picture is worth a thousand words.” Scientific approaches tend to prefer the direct meanings of words and sentences as expressed by the various definitions of the words in those sentences as opposed to their symbolic meanings as expressed by the various connotations they generate. For instance, laws are expressed in words, not symbols, since symbols are more open to interpretations. Furthermore, the words often have specific, legal meanings that may or may not coincide with their common usage or their connotation. Nevertheless, a symbol or symbolic meaning is more likely to encompass a feeling someone has than a statement simply because the picture it creates is far more comprehensive. Consequently, what may take an entire book to describe in words, can be captured in a single symbol. Symbols are frequent representations of feelings and complex concepts. For instance, a heart often symbolizes the feeling of love, while a wedding ring often symbolizes the concept of marriage. Often the intricacies and complexities of these feelings and concepts take on the form of an intuition for the entire collection.

A fourth object of this invention is to link the invention's first, second, and third objects through the use of a database of allegories specifically designed for business. In addition to being composed of symbols the allegories themselves become symbols of complex interpersonal concepts and the intuition associated with them. These allegories will serve to bring out the emotional commonalities of the audience in two ways. First, through the use of symbols that will appeal commonly to them, and second, through their existence as a mutual experience. To better illustrate the fundamental nature of this method, it can be related to the mythologies associated with various ancient civilizations. The myths comprising mythologies are unscientific and allegoric while a mythology represents a rudimentary database of allegories. Mythologies sought to bring out the common feelings people had about their world in a way that improved communicating those feelings, developed an affinity with one's world, encouraged certain actions, and established the basis for future learning.

While two people most likely would not create the exact same picture for a similar feeling, the pictures will most likely have a commonality. As an analogy, we can think of these two pictures as two drawings of a tree. While the trees will most likely be different, we will probably be able to see enough of a similarity between the two to determine that they are both trees. As humans we innately derive pictures that symbolize various feelings. Not only are our feelings similar but our symbols for those feelings are too. These types of symbols are called archetypes. Archetypes give humans the ability to express their emotions similarly to another human but in an individualistic manner. Since archetypes are often associated with deep, involved collections of feelings and concepts, they come closer to reflecting an intuition for something.

Just as a movie serves as a mutual experience for its viewers, allegories can serve as mutual experiences for the seminar's audience. Thus, the allegories become the vehicle by which the presenter can navigate discussion and questions along a general line in a particular direction. The method by which a presenter does this is similar to sailing, where the sailor is not able to maintain an exact line toward a destination but able to head in that direction along a serpentine course determined by the wind and its various gusts. Along the way other allegories can be called upon to help, depending upon where the discussion's wind carries. As a result, having an in depth understanding and appreciation for the allegories and their interrelationship with one another will help determine which one to use. Not only will this discussion eventually lead to points helping the development of more effective interpersonal relationships, but it will also serve to establish the intuition behind the complex emotions and concepts expressed by the allegory. Consequently, the same presenter, another presenter, the manager, or the employer will now have the ability to quickly and effectively symbolize it in future training so as to use it as a base upon which to build another concept, message, initiative, objective, or some other business effort.

The fifth object of this invention pertains to taking advantage of how the allegories work to realize the first four objects, improve interpersonal communication, an affinity for one's work, the encouragement for action, and conditions for future training. In order to understand how these allegories work it is important to look at ourselves and others as having two aspects: an outside and an inside. The outside aspect is the person exposed and seen by the world whereas the inside aspect is the person as he or she truly is. The question, “How much of a difference is there between who you are and who you think you are?” illustrates this concept.

The duality of this question manifests itself in the outside person protecting the inside one, while the inside seeks the growth that self-expression requires. Thus, there is a constant tension between the two because the growth ideally sought by the inside challenges the security practically sought by the outside; however, growth does not come without some risk. With any defense, the job becomes more difficult with the increase in territory in the form of more maintenance, energy, and vigilance. For instance, learning creates confidence but it takes confidence to expose the ignorance learning addresses. Anything new is unknown, and the unknown is potentially dangerous because of the potential exposure, humiliation, and physical harm. Thus, the outside person presses inward to thwart growth by cutting out or halting the actions of the inside person by instilling fear of being hurt or looking bad, while the inside presses outward to do the things he wants to do and have the things he wants to have.

The language of the outside person is pragmatic, centered on rationale, logic, reason, and cognition. The language of the inside person is idealistic and centered around emotion, desire, empathy, and intuition. In order to appeal to this inside person, one must get past the outside one standing guard. This is done by speaking the language of the inside, while distracting the outside. This requires an intuitive appeal cloaked in cognition. Since the outside person is protective and vigilant it will automatically greet a direct emotional appeal to the inside person with suspicion. Consciously, this tension often takes the form of talking or thinking to oneself and weighing the benefits and costs of an action. The inside person is generally the benefits' advocate while the outside is the costs'. Eventually, the outside rationalizes in favor or against whatever the inside prompts because there is a cultural tendency, especially in business, to have rationales for behaviors rather than simply saying, “That's my preference.”

This appeal works because the outside person is finite and the inside person is infinite. What we can consciously take in is always less than what is there. For example, after being in the woods it is impossible to consciously recall everything in it; yet, the feeling derived from it is far greater than what consciousness can recall. This is also reflected in the fact that no plan can account for everything that can possibly happen and the aspects of many plans do not reflect what actually happens. Clausewitz, who wrote On War, called this “friction.” “Who you are” is always far greater than “who you think you are.” The counterbalance is that while the inside person is more comprehensive he is also more sensitive, more easily hurt so as to retreat from his efforts to expand himself. The outside person, while far less comprehensive, is insensitive in the many ways a soldier must be in the heat of battle.

Appealing to the inside person by distracting the outside person happens frequently in our daily lives. Typically, we hear it in the form of “I need an excuse to talk to this person.” Implicatively, this is a desire to establish a relationship with a person but realizing that saying, “I want to establish a relationship,” is awkward and perhaps too direct. Similarly, at work, an employee who seeks to get in better with the boss will seek excuses to talk and interact with him. The conscious, protective function of the outside person cannot detect all that influences it because of its limited awareness as suggested by the above assumptions; thus, he becomes easily distracted by other stimuli he may find more immediate or important and becomes overwhelmed by the task of screening everything that comes at him. Consequently, many things get through to the inside person that the outside does not catch and manifest themselves as likes or dislikes for the person or object doing the influencing. As implied by the above assumptions, everything in the world influences people to some degree.

As this fifth object pertains to the allegories of this invention, the objective story associated with them distracts the outside person while their qualitative aspects such as shapes, colors, arrangement, detailing, words, and symbolisms influence the inside person. As an analogy, the difference between the two aspects is similar to that between science and art and between a house and a home.

The inventive process begins with the instructor addressing the audience, and asking the audience what information they want to hear. The seminar will have a particular topic that it is associated with, but the instructor, within the framework of the topic, will try to ascertain which areas of the topic the audience is most interested in. These questions can take any format that is designed to ascertain the audience's interest level in particular types of information relating to the seminar topic. Along with the questions posed by the instructor, the instructor will encourage the audience to ask questions of their own related to the seminar topic. In fact, many of the instructor's questions are designed to encourage and prompt questions from the audience. Any questions asked by the audience, in this particular embodiment of the invention, will not be answered at this time by the instructor.

Once the instructor has received input from the audience in the form of both comments and questions, the instructor will determine the best allegory to begin the presentation. The instructor begins the seminar with a select database of allegories available for use during the presentation. It is to be understood that the particular allegories that are included in the database of allegories are not intended to limit the invention in any manner. Any allegories can be used as long as chosen using sound business judgment.

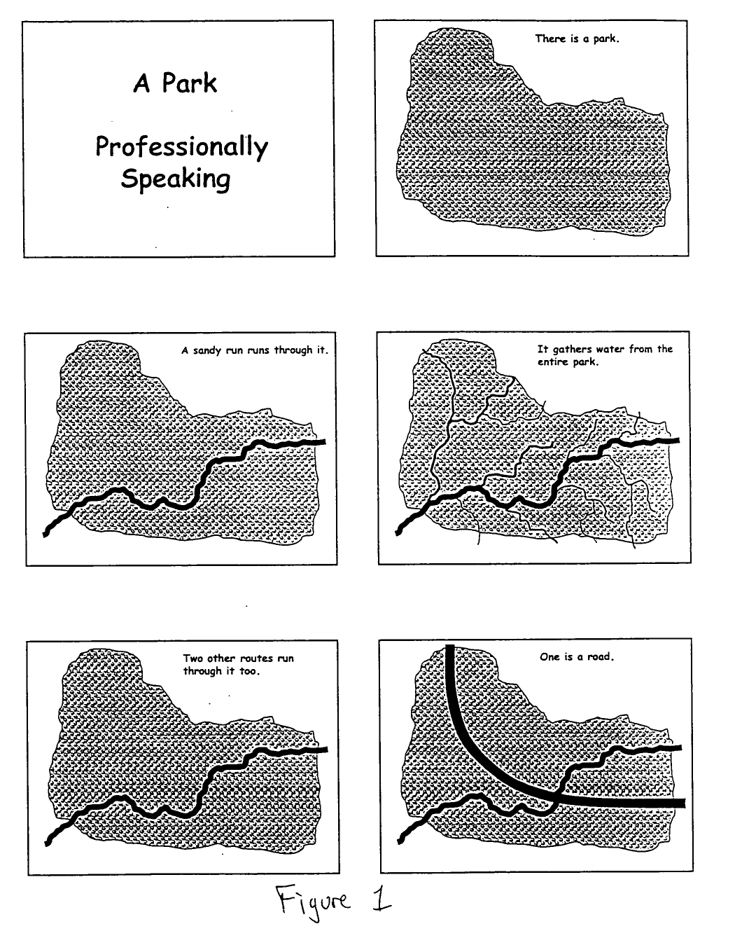

Once the instructor has chosen the first allegory that best fits with the questions and input from the audience, the instructor relays that allegory to the audience. With reference now to FIGS. 1-8, a representative allegory is shown. FIG. 1 shows a progression of six pictures beginning with a picture of a park, with the statement, “There is a park.” The next slide shows a winding river running through the park with the statement, “A sandy run runs through it.” The next slide shows tributaries to the winding river, with the statement, “It gathers water from the entire park.” The fourth slide shows the winding river again, with the statement, “Two other routes run through it too.” The fifth slide shows a road running across the river, with the statement, “One is a road.” This progression of slides shown in FIG. 1 is building the allegory, which will be used to generate a particular point for the seminar, while creating certain images for the audience.

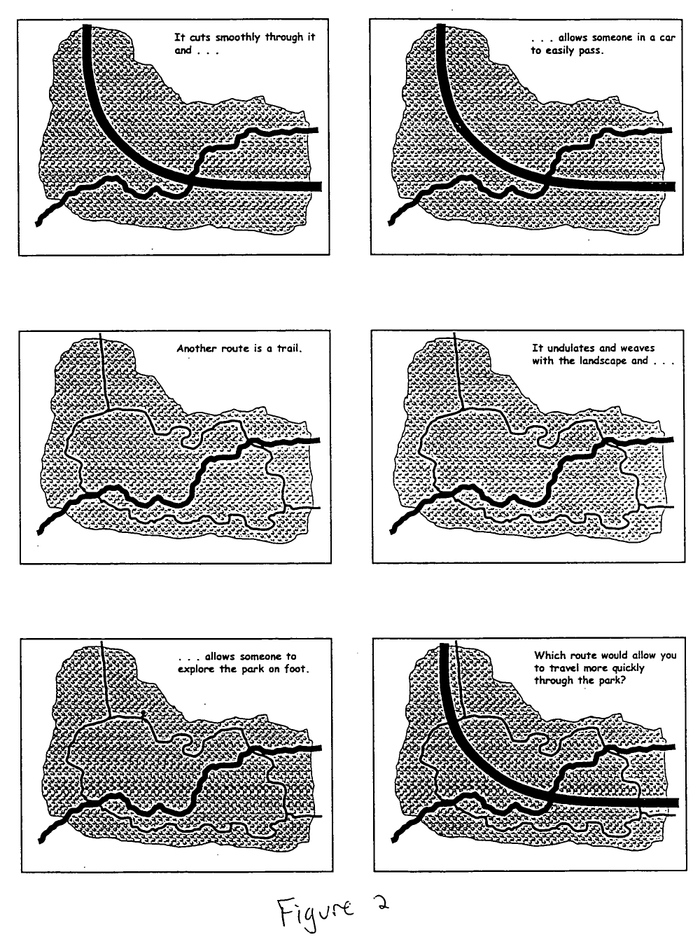

With reference now to FIG. 2, and the next six slides, the first slide again shows the road running across the river, with the statement, “It cuts smoothly through it and . . . ” The next slide continues the statement with, “. . . and allows someone in a car to easily pass.” The next slide adds a windy circuitous path that eventually leads across the park, with the statement, “Another route is a trail.” The next two slides have the same image, with the successive statements of, “It undulates and weaves with the landscape and . . . ” and “. . . allows someone to explore the park on foot.” The final slide shows the river, the road, and the path, with the statement, “Which route would allow you to travel more quickly through the park?” The audience has now been shown two separate choices, ending in the same place. The question is then posed regarding certain facts (i.e. which route would get you across the path the quickest).

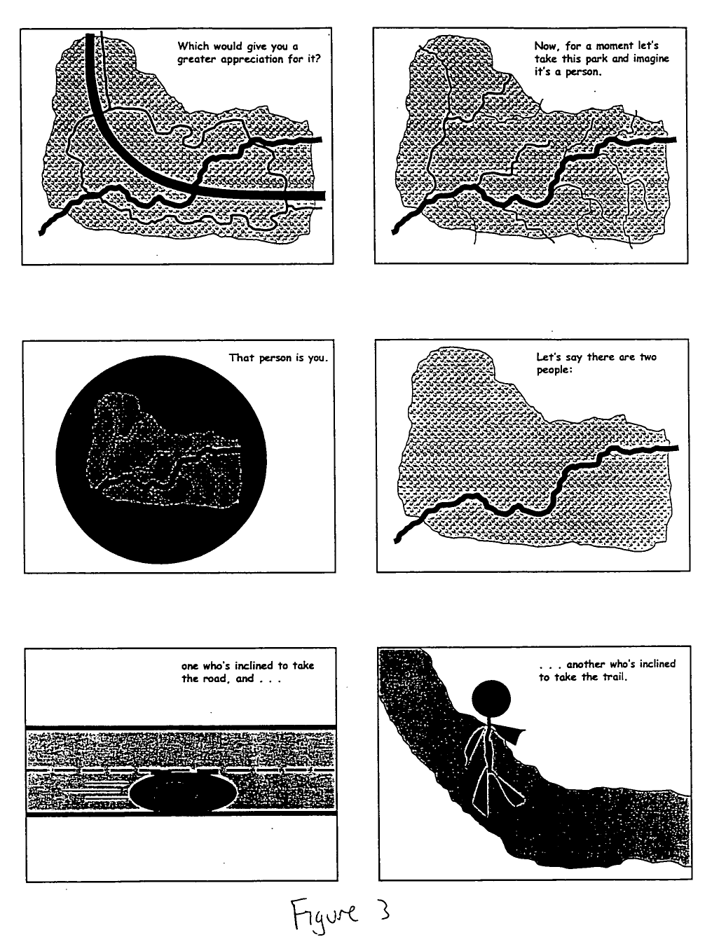

With reference now to FIG. 3, the first slide again shows the two routes and the river, with the statement, “Which would give you a greater appreciation for it?” The audience has now been asked to think about the allegory in a different manner. The thinking has now been shifted from getting across the park in the quickest manner to obtaining the best information about the park. The next slide shows the river with tributaries and the statement, “Now for a moment let's take this park and imagine it's a person.” The next slide has a dark circle surrounding the center of the previous slide and the statement, “That person is you.” The next slide has just the park and the river and the statement, “Let's say there are two people:” The next slide has a picture of road with a car on it and the statement, “one who's inclined to take the road, and . . . ” The last slide has a picture of a person walking on the other route, with the statement, “. . . another who's inclined to take the trail.” At the end of FIG. 3, the audience is now putting this into a personal arena from the standpoint of personalities.

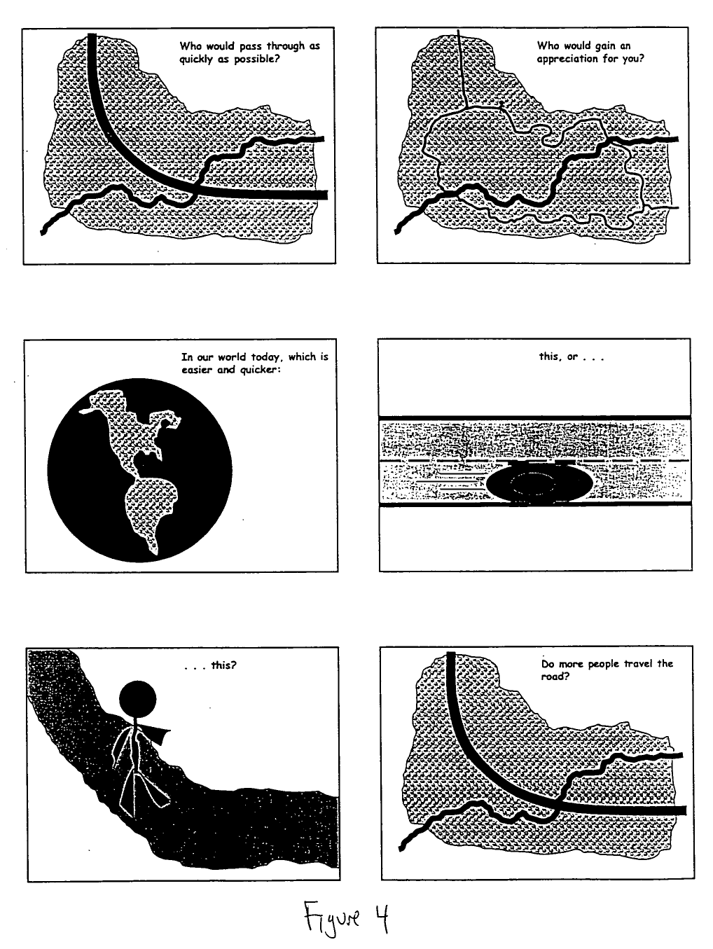

With reference now to FIG. 4, the first slide shows the road and the river and the statement, “Who would pass through as quickly as possible?” The next slide has the river and the circuitous path, with the statement, “Who would gain an appreciation for you?” The next slide shows a picture of a globe and the statement, “In our world today, which is easier and quicker:” The next slide has the picture of the car on the road and the statement, “this, or . . . ” The fifth slide has the picture of the person on the path and the statement, “. . . this?” The last slide has the picture of the road and the river with the statement, “Do more people travel the road?” FIG. 4 leads the audience through a thinking exercise to develop a thought process of the different ways of interacting with others.

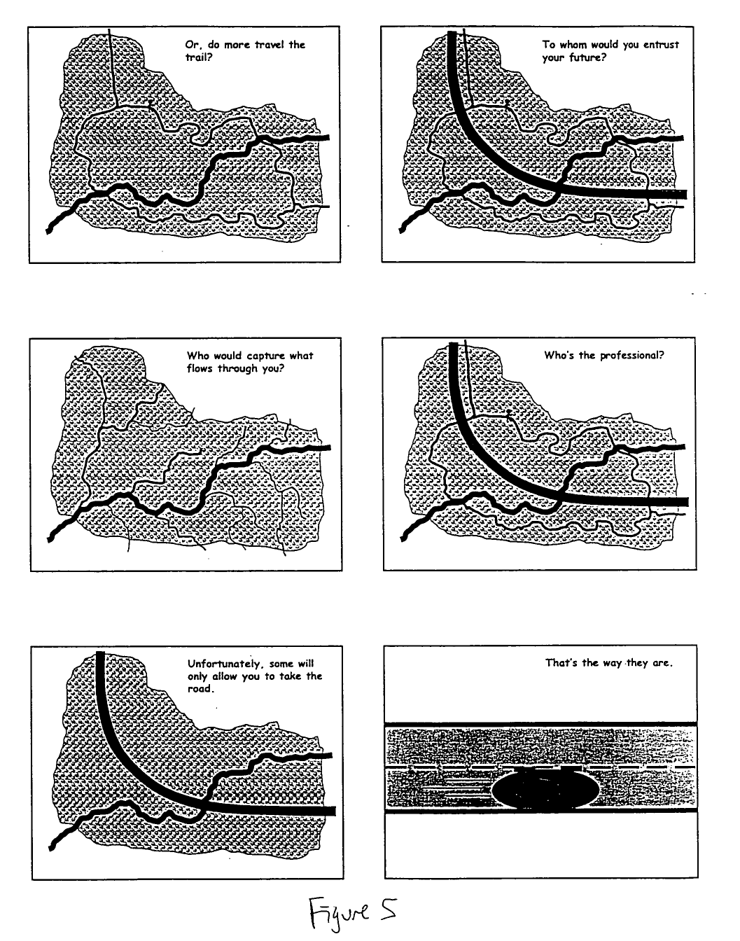

With reference to FIG. 5, the first slide shows the path and the river with the statement, “Or, do more travel the trail?” The next slide has the road, the path, and the river, with the statement, “To whom would you entrust your future?” The third slide has the river and the tributaries, with the statement, “Who would capture what flows through you?” The next slide has the road, the path, and the river again, with the statement, “Who's the professional?” The next slide is the road and the river and the statement, “Unfortunately, some will only allow you to take the road.” The last slide in FIG. 5 is the picture of the car on the road, with the statement, “That's the way they are.” The allegory, up through FIGS. 1-5 is a progression, aiding the audience in seeing things in more than one way. The allegory aids the audience to see human interrelation in an analogous way.

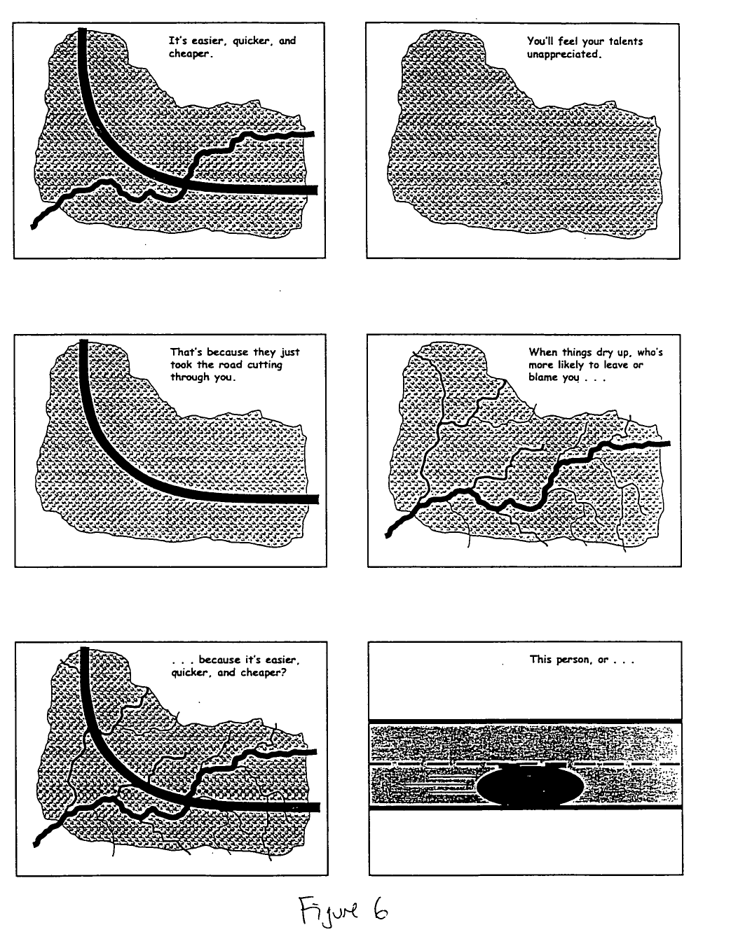

With reference now to FIG. 6, the first slide is the road and the river, with the statement, “It's easier, quicker, and cheaper.” The next slide is a picture of the park, with the statement, “You'll feel your talents unappreciated.” The next slide has the picture of the road going through the park, with the statement, “That's because they just took the road cutting through you.” The next slide shows the river and tributaries, with the statement, “When things dry up, who's more likely to leave or blame you . . . ” The next slide has the road going through the rivers and tributaries, with the statement, “. . . because it is easier, quicker, and cheaper?” The last slide of FIG. 6 is the car and the road, with the statement, “This person, or . . . ”

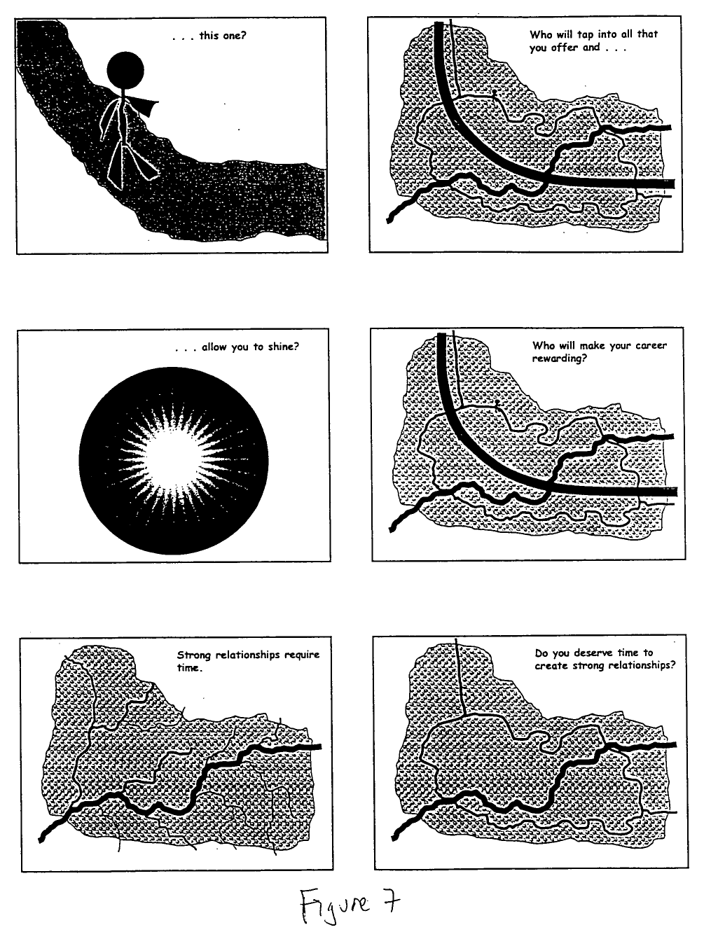

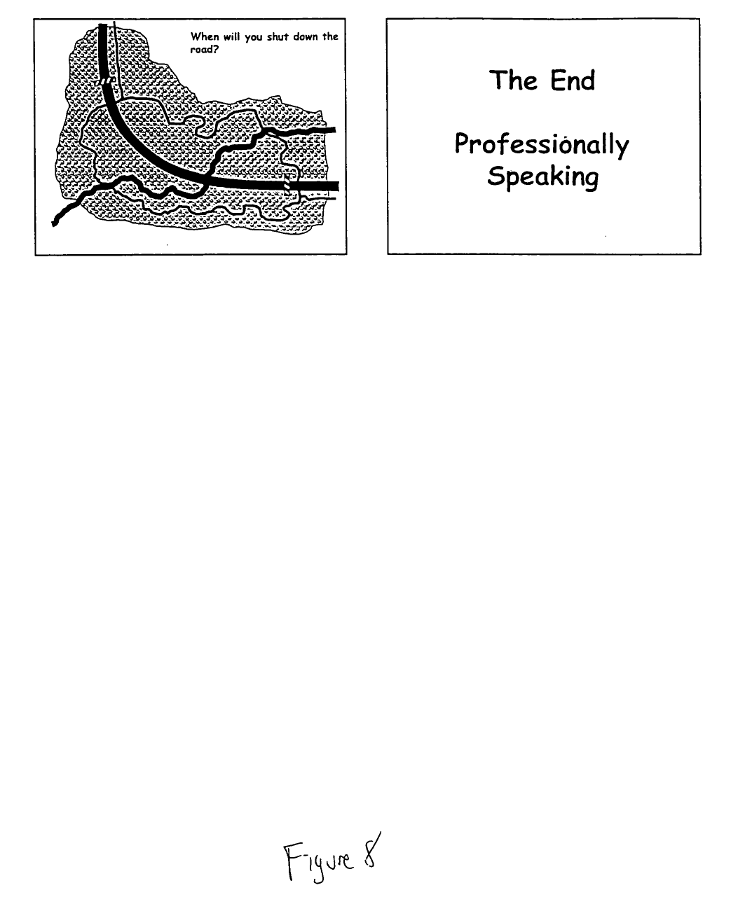

With reference now to FIG. 7, the first slide is the person walking on the path, with the statement, “. . . this one?” The next slide is the picture of the road and the path crossing the river, with the statement, “Who will tap into all that you offer and . . . ” The next slide is a picture of the sun and the statement, “. . . allow you to shine?” The next slide is the picture of the road and the path crossing the river, with the statement, “Who will make your career rewarding?” The next slide is the picture of the river and tributaries with the statement, “Strong relationships require time.” The last slide is the circuitous path and the river, with the statement, “Do you deserve time to create strong relationships?” With reference now to FIG. 8, the final slide of the allegory is a picture of the road and path crossing the river, but the road has a road block on it, with the statement, “When will you shut down the road?” The allegory teaches the audience that they should learn as much as possible about an individual, and the audience should look for business and personal relationships with people who are willing to spend time getting to know them.

It is to be understood that the allegory related in FIGS. 1-8 is only a representative sample of an allegory from the possible database, and is not intended to limit the invention in any manner. The particular use of this allegory could be modified as necessary. For example, more time could be spent on certain slides depending upon the needs, questions, and comments from the audience. A particular point may need to be emphasized more with a particular audience. It is also to be understood that the presentation of the allegory may include questions or comments from the audience. It is also to be understood that these allegories can be in any format chosen using sound judgment.

Once the first allegory has been completed, the determination of which allegory to use next is determined by the questions and comments from the audience during and after the recitation of the first allegory. The database of allegories has an interrelation with each other, but that interrelation can be different for different situations. As an analogy, if a particular card is pulled from a normal deck of cards, the next card in the sequence can be a number of different cards. For example, if the jack of spades is drawn, the next card in the sequence could be the queen of spades, the ten of spades, the jack of hearts, the jack of clubs, etc. This analogy applies to the allegories as well. The database of allegories, and in particular, the allegories used during a particular seminar have an interrelation, but that interrelation can change based upon the comments and questions elicited from the audience.

Based upon the previous allegory and the questions and comments of the audience from the first allegory; the particular qualities of the first, second, and potentially future allegories; the judgment of the instructor; the seminar topic; and the audiences questions and comments from the seminar's outset; the instructor then chooses a second allegory.

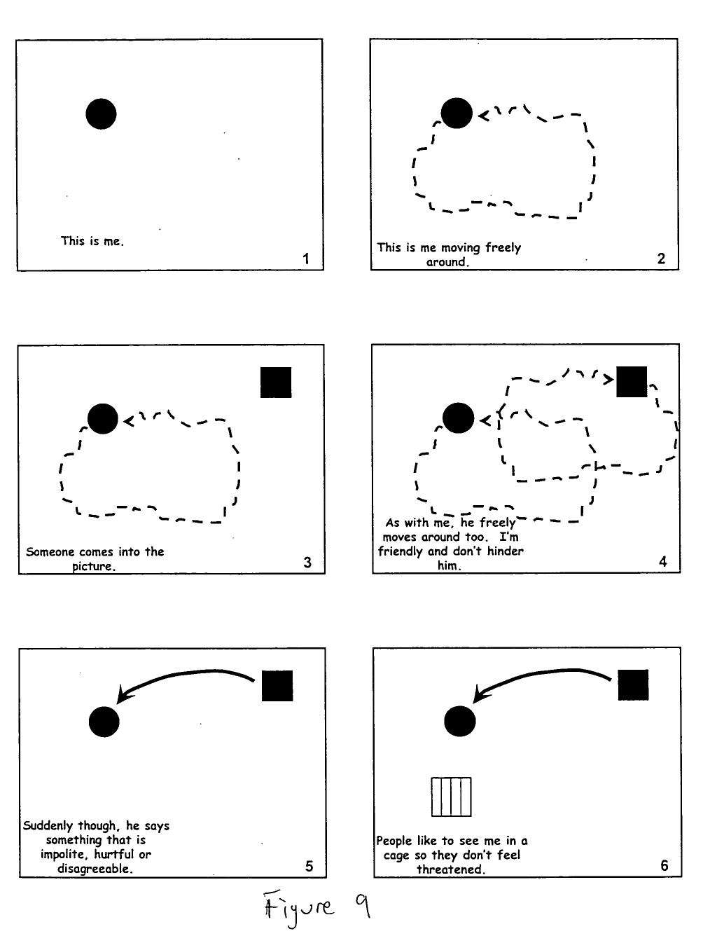

With reference now to FIGS. 9-16, a representative second allegory is shown that potentially could follow the representative first allegory. For example, a comment or question, or a series of comments and questions, from the audience indicating to the instructor that the audience may feel the point of the first allegory was too simple or obvious could lead the instructor to select this representative second allegory.

FIG. 9 shows a progression of six pictures beginning with a picture of a blue circle, with the statement, “There is me.” The next slide, NUMBER 2, shows a winding, blue, broken arrow running from the left side of the blue circle and finishing at the right side of the blue circle with the statement, “This is me moving freely around.” The next slide, NUMBER 3, shows again the blue circle with the winding, blue, broken arrow with the addition of a red square in the upper right hand corner with the statement, “Someone comes into the picture.” The fourth slide, NUMBER 4, shows a winding, red, broken arrow running from the right side of the red square and finishing at the left side of the red square, with the statements, “As with me, he freely moves around too. I'm friendly and don't hinder him.” The fifth slide, NUMBER 5, shows just the blue circle and the red square with a solid red, curved arrow running from the square's left side to the top, right portion of the blue circle, with the statement, “Suddenly though, he says something that is impolite, hurtful or disagreeable.” The sixth slide, NUMBER 6, shows the blue circle, the red square, the solid red, curved arrow and a black square outline with three equally spaced vertical lines running from the top of the square to the bottom that represents a cage with the statement, “People like to see me in a cage so they don't feel threatened.” This progression of slides shown in FIG. 9 is building the representative second allegory, which will be used to generate a particular point for the seminar by building upon the point from the first representative allegory, while creating certain additional images for the audience.

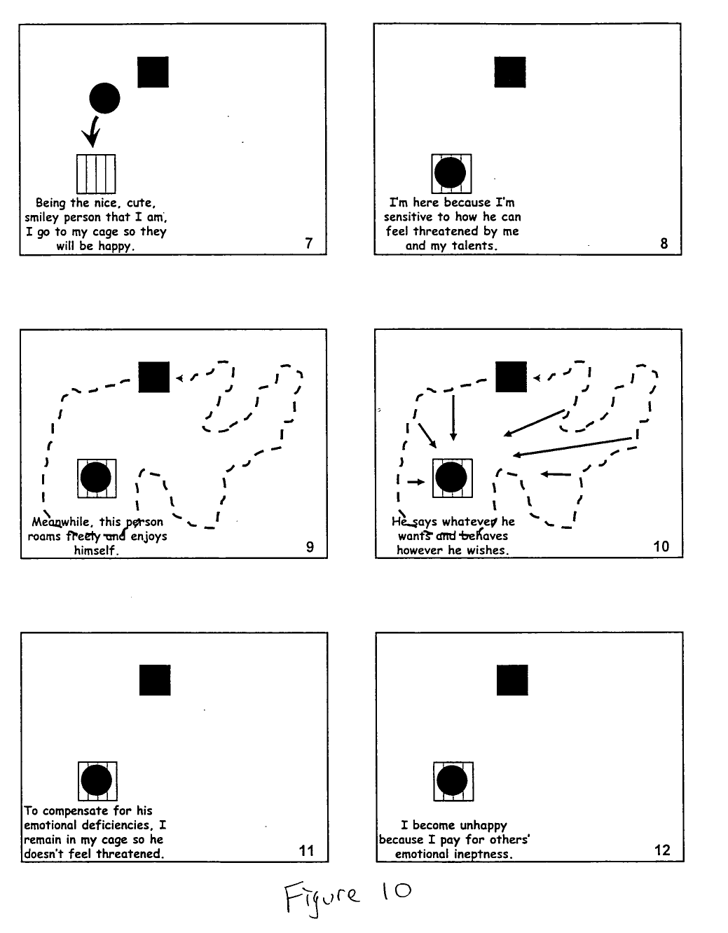

With reference to FIG. 10 and the next six slides the first slide, NUMBER 7, shows the blue circle, the red square close to the top right of the circle, and the black square with vertical lines representing a cage with the addition of a shorter solid blue, curved arrow running from the bottom of the blue circle to the top of the cage with the statement, “Being the nice, cute, smiley person that I am, I go to my cage so they will be happy.” The second slide, NUMBER 8, shows the blue circle now in the cage with the statement, “I'm here because I'm sensitive to how he can feel threatened by me and my talents.” The third slide, NUMBER 9, shows the blue circle again in the cage and the red square with the addition of a winding, red, broken arrow running from the left side of the square around to the bottom of the slide and back up to the right side of the square with the statement, “Meanwhile, this person roams freely and enjoys himself.” The fourth slide, NUMBER 10, repeats the previous slide with the addition of six solid, straight lines running from various parts of the winding, red, broken arrow and pointing toward the blue circle in the cage with the statement, “He says whatever he wants and behaves however he wishes.” The fifth slide, NUMBER 11, and sixth slide, NUMBER 12, repeat the second slide, NUMBER 8, in FIG. 10 with the successive statements of, “To compensate for his emotional deficiencies, I remain in my cage so he doesn't feel threatened,” and “I become unhappy because I pay for others' emotional ineptness.” This progression of slides shown in FIG. 10 continue to build the representative second allegory, while still creating certain additional images and building upon previous images for the audience.

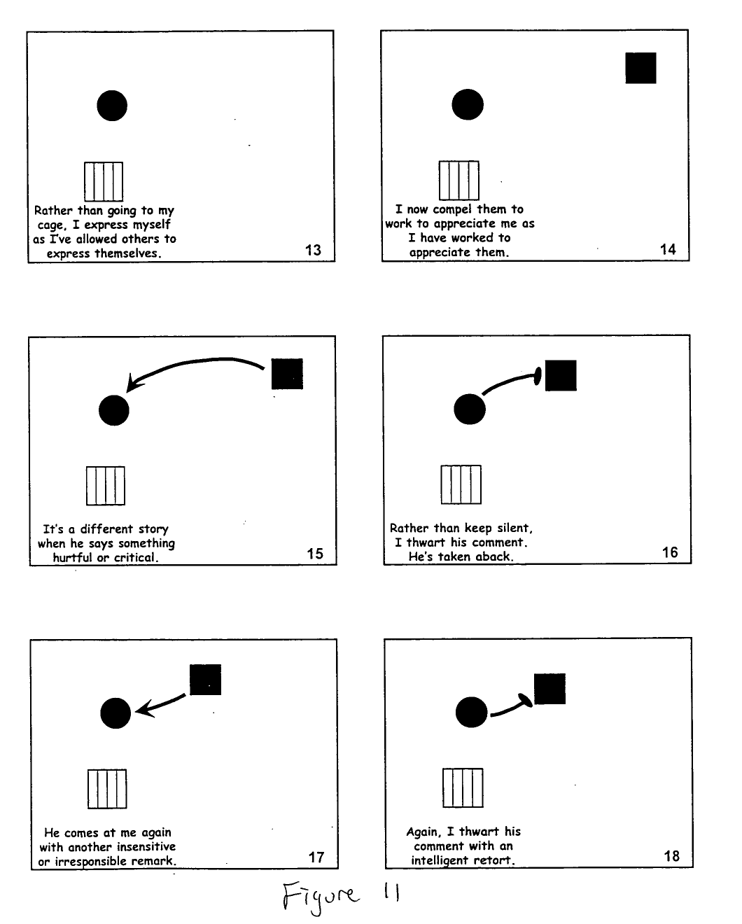

With reference to FIG. 11 and the next six slides the first slide, NUMBER 13, shows the blue circle slightly above the cage with the statement, “Rather than going to my cage, I express myself as I've allowed others to express themselves.” The second slide, NUMBER 14, repeats the blue circle and cage with the addition of the red square in the upper right hand corner with the statement, “I now compel them to work to appreciate me as I have worked to appreciate them.” The third slide, NUMBER 15, repeats the sixth slide, NUMBER 6, from FIG. 9 with the statement, “It's a different story when he says something hurtful or critical.” The fourth slide, NUMBER 16, no longer shows the red arrow, shows the red square closer to the blue circle and a solid, blue, blocking line emitting from the top, right portion of the blue circle and ending in a small, blue, oval perpendicular to the path of the blue line against the left side of the red square with the statements “Rather than keep silent, I thwart his comment. He's taken aback.” The fifth slide, NUMBER 17, shows a short, solid, red, curved arrow running from the lower left hand corner of the square to the right side of the blue circle with the statement, “He comes at me again with another insensitive or irresponsible remark.” The sixth slide, NUMBER 18, replaces the red arrow by showing a short, curved, solid blue blocking line in its place running from the right of the circle to the lower left hand corner of the red square with the statement, “Again, I thwart his comment with an intelligent retort.” This progression of slides shown in FIG. 11 continue to build the representative second allegory by retelling a different version in FIGS. 9 and 10 while still creating certain additional images and building upon previous images for the audience.

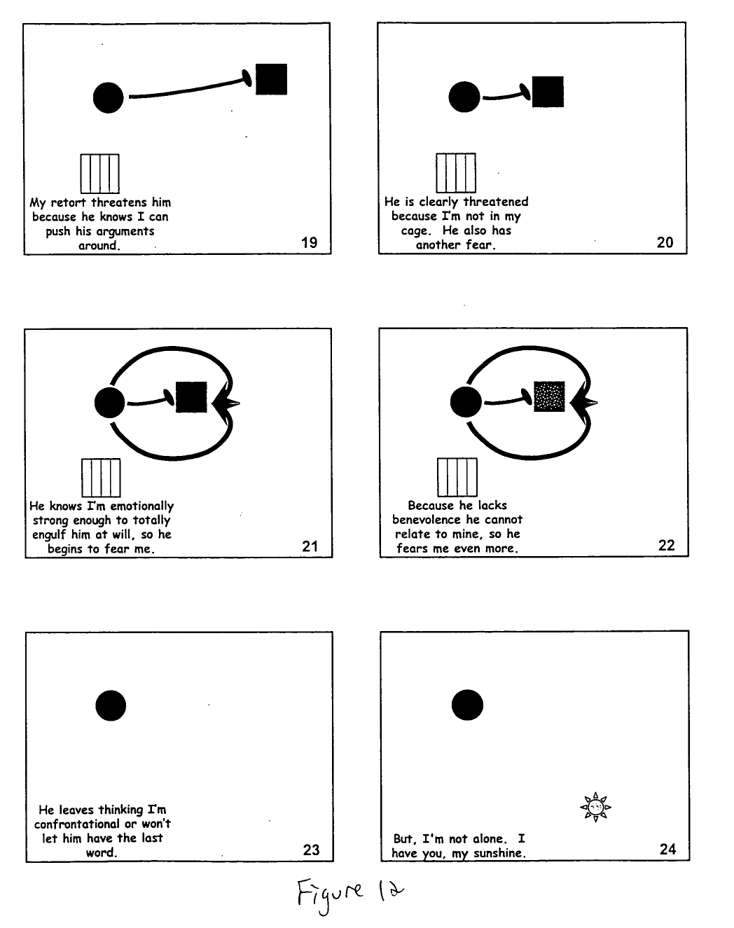

With reference to FIG. 12 and the next six slides the first slide, NUMBER 19, shows the blue circle slightly above the cage, the red square in the upper right hand corner, and a solid, blue, blocking line running from the right of the circle to the left side of the red square with the statement, “My retort threatens him because he knows I can push his arguments around.” The second slide, NUMBER 20, shows the red square closer and the solid, blue blocking line shorter with the statements, “He is clearly threatened because I'm not in my cage. He also has another fear.” The third slide, NUMBER 21, shows the addition of two encircling, blue, solid arrows where one curves from the top of the circle around to the right side of the square and the other curves from the bottom of the circle around to the right side of the square with the statement, “He knows I'm emotionally strong enough to totally engulf him at will, so he begins to fear me.” The fourth slide, NUMBER 22, shows the red square as bluish red with the statement “Because he lacks benevolence he cannot relate to mine, so he fears me even more.” The fifth slide, NUMBER 23, repeats the first slide, NUMBER 1, of FIG. 9 with the statement, “He leaves thinking I'm confrontational or won't let him have the last word.” The sixth slide, NUMBER 24, shows a yellow sun in the lower right hand corner with the statements, “But, I'm not alone. I have you, my sunshine.” This progression of slides shown in FIG. 12 concludes this second version of the representative second allegory and begins to build upon it by introducing the sun furthering the creation of certain additional images and the building upon previous images for the audience.

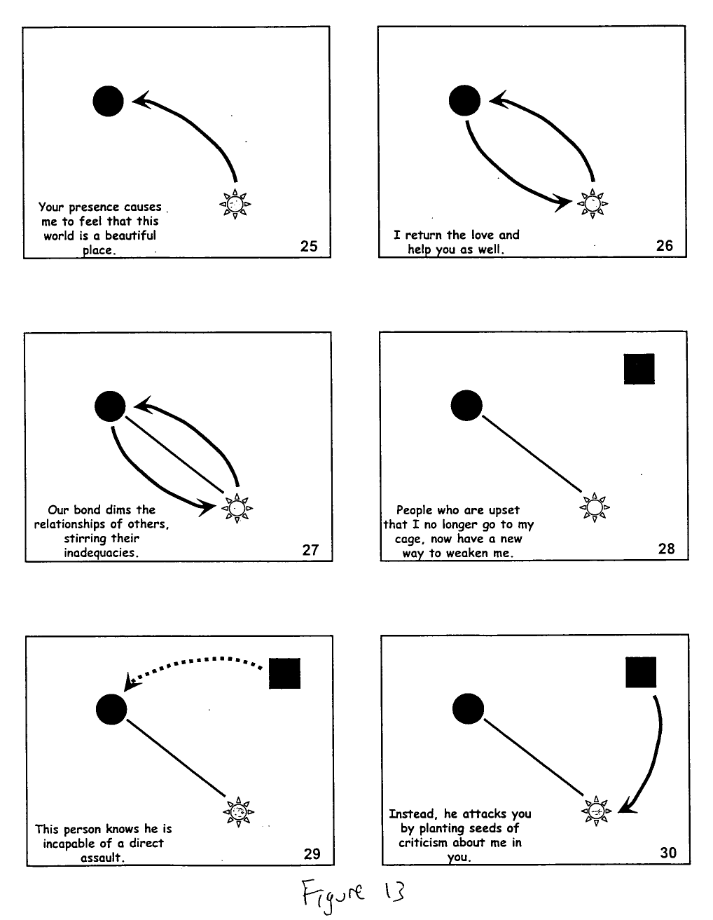

With reference to FIG. 13 and the next six slides the first slide, NUMBER 25, shows the blue circle, the yellow sun, and a solid, yellow, curved arrow running from the top of the sun to the right of the blue circle with the statement, “Your presence causes me to feel that this world is a beautiful place.” The second slide, NUMBER 26, shows a solid, green, curved arrow running from the bottom of the blue circle to the left of the yellow sun with the statement, “I return the love and help you as well.” The third slide, NUMBER 27, shows a solid, straight blue and yellow line connecting the blue circle and yellow sun with the statement, “Our bond dims the relationships of others, stirring their inadequacies.” The fourth slide, NUMBER 28, removes the green and yellow arrows and shows the red square in the upper right hand corner with the statement, “People, who are upset that I no longer go to my cage, now have a new way to weaken me.” The fifth slide, NUMBER 29, shows a dotted, red, curved arrow running from the right side of the red square to the top, right portion of the circle with the statement, “This person knows he is incapable of a direct assault.” The sixth slide, NUMBER 30, shows a solid, red, curved arrow running from the bottom right corner of the red square to the right of the yellow sun with the statement, “Instead, he attacks you by planting seeds of criticism about me in you.” This progression of slides shown in FIG. 13 continues to build upon this second version of the representative second allegory and creating certain additional images and building upon previous images for the audience.

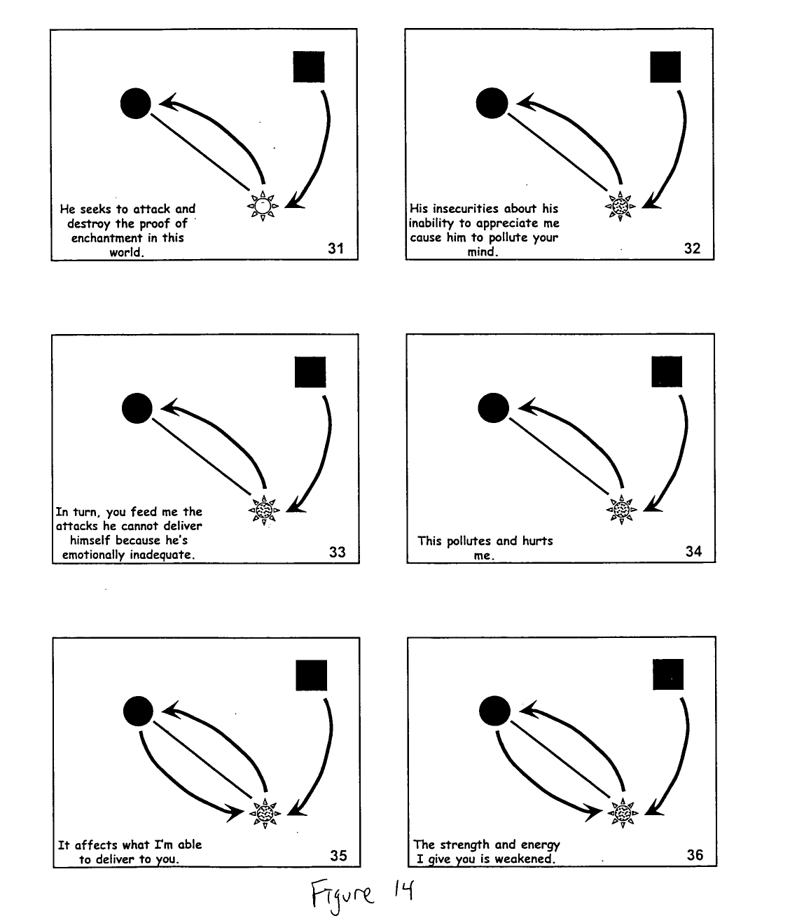

With reference to FIG. 14 and the next six slides the first slide, NUMBER 31, shows the blue circle, the yellow sun, the red square, the red arrow, and the return of the solid, straight, blue and yellow line running between the blue circle and the yellow sun with the statement, “He seeks to attack and destroy the proof of enchantment in this world.” The second slide, NUMBER 32, shows the yellow sun as reddish, yellow with the statement, “His insecurities about his inability to appreciate me cause him to pollute your mind.” The third slide, NUMBER 33, shows the yellow arrow as a reddish, yellow arrow with the statement, “In turn, you feed me the attacks he cannot deliver himself because he's emotionally inadequate.” The fourth slide, NUMBER 34, shows the blue circle as darker with the statement “This pollutes and hurts me.” The fifth slide, NUMBER 35, shows the return of the green arrow established in the second slide, NUMBER 26, of FIG. 13 with the statement, “It affects what I'm able to deliver to you.” The sixth slide, NUMBER 36, shows the green line as darker with the statement, “The strength and energy I give you is weakened.” This progression of slides shown in FIG. 14 continues to build upon this second version of the representative second allegory and creating certain additional images and building upon previous images for the audience.

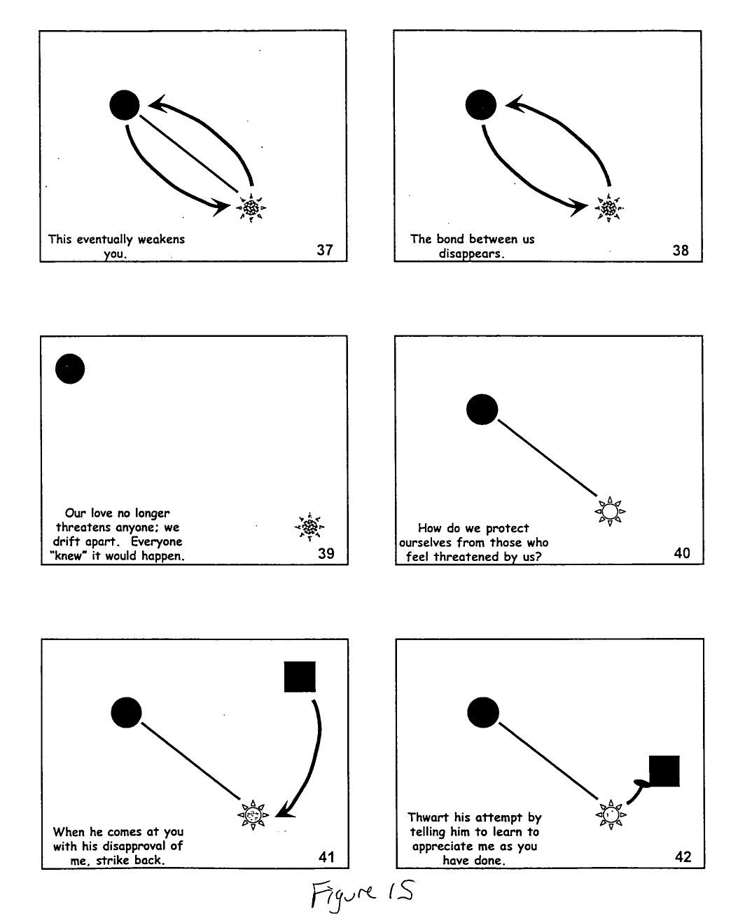

With reference to FIG. 15 and the next six slides the first slide, NUMBER 37, shows a darker blue circle, a darker yellow sun, a darker green arrow, a darker yellow arrow, and the blue and yellow line with the statement, “This eventually weakens you.” The second slide, NUMBER 38, repeats the previous slide without the blue and yellow line with the statement, “The bond between us disappears.” The third slide, NUMBER 34, shows the darker blue circle in the upper left hand corner and the darker yellow circle in the lower right hand corner with the statements, “Our love no longer threatens anyone; we drift apart. Everyone ‘knew’ it would happen.” The fourth slide, NUMBER 40, shows the blue circle, the yellow sun, and the blue and yellow line in their previous locations as first shown in the fourth slide, NUMBER 28, of FIG. 13 with the question “How do we protect ourselves from those who feel threatened by us?” The fifth slide, NUMBER 41, repeats the sixth slide, NUMBER 30, of FIG. 13 with the statement, “When he comes at you with his disapproval of me, strike back.” The sixth slide, NUMBER 31, shows the red square closer to the yellow sun with a solid, yellow, curved blocking line running from the upper right portion of the sun to the lower left hand corner of the red square with the statement, “Thwart his attempt by telling him to learn to appreciate me as you have done.” This progression of slides shown in FIG. 15 concludes the building of the second version of the representative second allegory and introduces another version of the second version by creating certain additional images and building upon previous images for the audience.

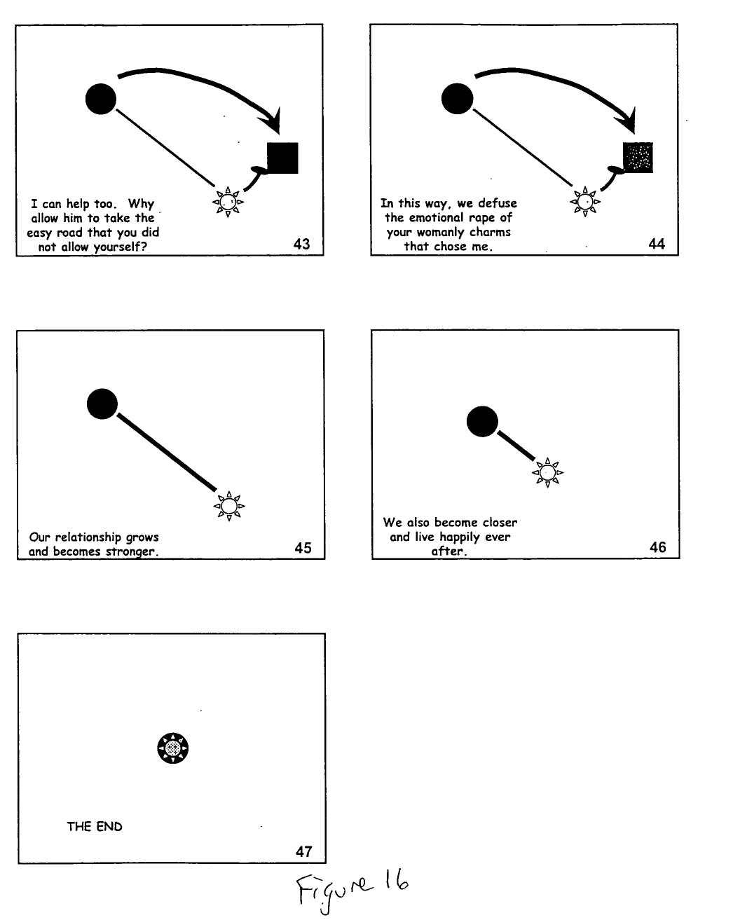

With reference to FIG. 16 and the final five slides the first slide, NUMBER 43, shows the blue circle, the yellow sun, the red square, the blue and yellow straight line, and the yellow blocking arrow with the addition of a solid, blue, curved arrow running from the upper right portion of the blue circle to the top of the square with a successive statement and question, “I can help too. Why allow him to take the easy road that you did not take yourself?” The second slide, NUMBER 44, shows the red square as bluish red with the statement, “In this way, we defuse the emotional rape of your womanly charms that chose me.” The third slide, NUMBER 45, shows a thicker blue and yellow line with the statement, “Our relationship grows and becomes stronger.” The fourth slide, NUMBER 46, shows the blue circle and yellow sun closer with a shorter, thick blue and yellow line with the statement “We also become closer and live happily ever after.” The final slide of the allegory, NUMBER 47, shows the yellow sun superimposed on the blue circle with the statement, “THE END.” An aspect of relationships that the allegory teaches the audience is that they need to be aware of the influences of others on them and on those with whom they seek to build stronger interpersonal relationships.

Since the representative second allegory appears on the surface as a story of a relationship between a man and a woman, a potential first perspective for the instructor to take could be making the symbolic connection among this allegory, the discussion and questions around the first allegory, the seminar's topic, and the business field of the audience. An instructor could begin making this connection by asking the audience to address the question, “How does this (the allegory) relate to our discussion?” Ultimately, a likely connection between this allegory and the first could be that there are potential influences that may determine an individual audience member's ability to relate to others. Forming strong relationships with others means realizing that others outside that relationship can influence an audience member's ability to relate to the person with whom to make a stronger relationship. A conclusion the instructor could help the audience arrive at from the first and second allegories could be that working to understand someone may not be easy if they are not aware of the influences acting upon them.

It is to be understood that the allegory related in FIGS. 9-16 is only a representative sample of an allegory from the possible database, and is not intended to limit the invention in any manner. The particular use of this allegory could be modified as necessary including its sequential use relative to other allegories as determined by the judgment of the instructor. For example, this allegory could have appeared as first, third, fourth, any other position, or not at all. Furthermore, the presentation of the allegory by the instructor could give more time to certain slides depending upon the needs, questions, and comments from the audience. A particular point may need to be emphasized more with a particular audience. It is also to be understood that the presentation of the allegory may include questions or comments from the audience. It is also to be understood that these allegories can be in any format chosen using sound judgment.

This second allegory is related in much the same way as the first allegory, with questions and comments from the audience possible throughout. The second allegory builds on the first allegory and is part of the chain of small incremental steps to move from one point to a final point. Frequently, the final point to be made is to change the audience's thinking from the general normative mentality, to a more in-depth mode of thinking, or to allow the audience to view things in several different lights. The allegories are used to help people learn how to understand and appreciate people better and thereby improve their interpersonal relationships.

Once the second allegory is completed, the process is continued again through as many allegories as necessary to reach the final conclusion of the seminar. The number of allegories can change depending upon the questions and comments of the audience. As mentioned before, the order of the allegories is determined by the questions and comments of the audience during and after the allegories, questions and comments at the outset of the seminar, the seminar's specific topic, and the interconnectedness of the allegories. The instructor must be familiar with all of the available allegories and how they can relate to each other so that the instructor is able to determine the next allegory based upon the audience's questions and comments.

Once the final allegory has been told, and the audience has made all of its comments, and asked all of its questions, the allegories should all interconnect to make a progression from a first point to a final point, the final point giving the audience a method for improving their interpersonal relationships. The allegories direct people's thinking away from the conventional and toward the relational so that the audience can understand and appreciate how events in people's lives interconnect with each other and effect interpersonal relationships. The allegories are designed to help people to enhance their interpersonal relationships through a better understanding and appreciation for the importance that process and interconnectedness play. As an analogy, if we consider a sailboat navigating through the water via the wind to a particular destination, the sailboat could represent the seminar, the sailor as the instructor, the wind as the questions and comments from the audience, and the destination as the topic of the seminar. How and where the sailboat goes will depend upon the direction of the wind, the destination of the sailboat, and the judgment of the sailor. This will likely cause two journeys between the same origination and destination points to vary because the wind will not likely blow in exactly the same fashion for each journey. Nevertheless, there is a learnable process associated with sailing even though no two journeys can be duplicated.

In another embodiment of this invention, or as an addition to the previous embodiment, the present invention can utilize songs and/or movies as illustrations to derive a particular point. For example, the instructor can show the audience the lyrics to a particular song, then break the lyrics down into sections. For example, a particular song may have five main lines that show a connection to the point the instructor is trying to convey. The instructor will then proceed through the various lines of the song, explaining the connection between the lyrics and the point the instructor is trying to make. As above, the instructor will welcome and encourage questions or comments from the audience. In a similar manner, the instructor could utilize various scenes from a movie to illustrate a particular point. The lyrics from songs and/or scenes from movies can be used alone, or may be integrated within the various allegories.

The instructor will know the difference this invention makes between allegories, songs, and movies as most likely one involving mutual experiences and images for the audience and as most likely another involving business intention. There are two aspects to mutual experiences. First, there is the aspect of knowing and recalling the same song or movie. Second, there is the aspect of sharing the experience with others. For example, while all audience members may have heard a song or seen a movie, they may not have heard and seen it at the same time and place. Business intention refers to the fact that the allegories in this invention's database are intended for learning aspects of business. Songs and movies in the public domain, for the most part, are not generally intended for learning aspects of business. Nevertheless, the instructor will know that using something considered unrelated to, and outside the realm of, a topic in a way that makes an unexpected relationship can strongly influence the audience. People prefer an imperfect original to a perfect copy.

From an instructional perspective, the instructor will most likely use allegories in a more comprehensive way to establish a broader array of images upon which to build and make points while songs and movies will most likely focus on a specific point or image either in the creation of it or in the reinforcement of one from an allegory, song, or movie. From a time-management perspective, the instructor will most likely have allegories using more time than songs and movies. It is to be understood that the difference between allegories and songs and movies is only an instructional one and is not intended to limit the invention in any manner. The integration of allegories, songs, and movies could be modified as necessary depending upon the judgment of the instructor.

With reference now to the above-mentioned songs and movies, there are three examples of songs and three examples of movies to use shown. A representative song is, “Danger Zone”, the source of the song, the movie Top Gun, and the author, Kenny Loggins.

| | |
|---|---|
| Revvin' up your engine | You'll never say hello to you |
| Listen to her howlin' roar | Until you get on the red line |
| Metal under tension | overload |
| Beggin' you to touch and go | You'll never know what you can do |
| Highway to the Danger Zone | Until you get it up as high as you |
| Ride into the Danger Zone | can go |
| Headin' into twilight | Out along the edges |
| Spreadin' out her wings tonight | Always where I burn to be |
| She go you jumpin' off the deck | The further on the edge |
| And shovin' into overdrive | The hotter the intensity |
| Highway to the Danger Zone | Highway to the Danger Zone |
| I'll take you | Gonna take you |
| Right into the Danger Zone | Right into the Danger Zone |
| | Highway to the Danger Zone |

Beneath these are the lyrics with the particular lines, “You'll never say hello to you,” “Until you get on the red line overload,” “You'll never know what you can do,” and “Until you get it up high as you can go,” bolded and underlined to indicate the aspect of the song for the audience to address. The lyrics of the entire song concern the testing of limits a fighter pilot can experience. As represented in this song, the area where this test occurs is the Danger Zone. The highlighted lyrics represent how fighter pilots must personally challenge themselves to really get to know themselves and what they are able to do. The highlighted lyrics also imply that this challenge is one in which the fighter pilots often end up doing things that they have never done before. With the lyrics of the entire song and the highlighted ones, the instructor could take the perspective of connecting audience members to a fighter pilot and the Danger Zone to the testing of one's emotional limits in a relationship. A perspective point the instructor could emphasize is the expectation that stronger interpersonal relationships may require the reaching for emotional limits not yet experienced.

Another representative song is “Right Now”, the source of the song, the group Van Halen, and the author, Edward Van Halen.

| | |
|---|---|
| Don't wanna wait 'til tomorrow | (Right now) Hey, it's your tomorrow |
| Why put it off another day? | (Right now) Come on, it's everything |
| One by one, little problems | (Right now) catch that magic moment |
| Build up, and stand in our way. Oh | Do it right here and now |
| One step ahead, one step behind it | It means everything |
| Now ya gotta run to get even | Said a lie to me |
| Make future plans I'll dream about | Right now |
| yesterday, hey! | What are ya waitin' for? Oh! Yeah! |
| Come on turn, turn this thing | Right now |
| around | (Guitar Solo) |
| (Right now) Hey! It's your | (Right now) |
| tomorrow | Hey! It's your |
| (Right now) Come on, it's | tomorrow |
| everything | (Right now) Come on, it's everything |
| (Right now) Catch your magic | (Right now) Catch that magic |
| moment | moment |
| Do it right here and now | And do it right, right now (Right |
| It means everything | now) |
| Miss a beat, you lose a rhythm | Oh, right now! |
| An nothin' falls into place. No! | It's what's happening |
| Only missed by a fraction | Right here and now |
| Slipped a little off your pace. Oh! | Right now, it's right now |
| The more things you get, the more | Oh! |
| you want | Tell me, what are ya waitin' |
| Just trade in one for another | for? |
| Workin' so hard to make it easy | Turn this thing around |
| Whoa, got to turn. Come on, turn | |
| this thing around | |

In particular, the lyrics have the particular lines, “Don't wanna wait 'til tomorrow,” “Why put it off another day?” “One by one, little problems,” “Build up, and stand in our way. Oh,” “One step ahead, one step behind it,” “Now ya gotta run to get even,” “Catch your magic moment,” “Miss a beat, you lose a rhythm,” “An nothin” falls into place. No!”, “Only missed by a fraction,” and “Slipped a little of your pace,” bolded and underlined to indicate the aspects of the song for the audience to address. The lyrics of the entire song concern making the most of every moment in a life. As represented in this song, the way to do this is to seize the magic moment right now and avoid putting it off until tomorrow. The highlighted lyrics represent the problems people can create for themselves by not following the advice in the song. The highlighted lyrics also imply there is something magic in the moment at hand that will most likely be gone tomorrow. With the lyrics of the entire song and the highlighted ones, the instructor could take the perspective of connecting audience members' daily interactions with others as the magic moments. A perspective point the instructor could emphasize is the expectation that stronger interpersonal relationships may require making the most of the moment at hand because there may be the opportunity to make substantial gains in the relationship.

Another representative song is “Rock and Roll All Nite,” by the group KISS, and the authors, Paul Stanley and Gene Simmons.

| | |
|---|---|
| You show us everything you've got | You keep on saying you'll be mine for |
| You keep on dancin' and the room gets | a while |
| hot | You're lookin' fancy and I like your |
| You drive us wild, we'll drive you crazy | style |
| You say you wanna go for a spin | You drive us wild, we'll drive you crazy |
| The party's just begun, we'll let you in | You show us everything you've got |
| You drive us wild, we'll drive you crazy | Baby, baby that's quite a lot |
| You keep on shoutin', you keep on | And you drive us wild, we'll drive you |
| shoutin' | crazy |
| I wanna rock and roll all nite and party | You keep on shoutin', you keep on |
| every day | shoutin' |
| I wanna rock and roll all nite and party | I wanna rock and roll all nite and party |
| every day | every day |
| I wanna rock and roll all nite and party | I wanna rock and roll all nite and party |
| every day | every day |
| I wanna rock and roll all nite and party | I wanna rock and roll all nite and party |
| every day | every day |
| | I wanna rock and roll all nite and party |
| | every day |
| | I wanna rock and roll all nite and party |
| | every day |
| | I wanna rock and roll all nite and party |
| | every day |
| | I wanna rock and roll all nite and party |
| | every day |
| | I wanna rock and roll all nite and party |
| | every day |
| | I wanna rock and roll |

These lyrics have the particular line, “You drive us wild, we'll drive you crazy,” bolded and underlined twice to indicate the aspect of the song for the audience to address.

The lyrics of the entire song concern the musical group's address to its audience. As represented in this song, the group is encouraging the audience to help them make the concert a great one through their participation as symbolized by the audience shouting “I wanna rock and roll all nite and party every day.” The highlighted lyrics represent how this mutual effort to make a great concert will work; through a synergistic cycle of the audience encouraging the group and the group playing well. With more encouragement from the audience, the group plays better. As the group plays better, it receives more encouragement from the audience. With the lyrics of the entire song and the highlighted ones, the instructor could take the perspective of connecting audience members to the group and their clients or other people as their audience. A perspective point the instructor could emphasize is that stronger interpersonal relationships may require a synergistic effect in which audience members need to encourage the participation and effort of those with whom they seek to interact.

Now a representative movie is shown. The title of the movie is Top Gun. The particular lines, “You don't have time to think up there. If you think, you're dead,” and “Gutsiest move I ever saw, man” are key lines from the movie. With respect to these lines, the first is associated to the character “Maverick” and the second to the character “Slider.” As represented by the script, this is a critique conducted by two instructors challenging the handling of a fighter plane by the fighter pilot Maverick in front of a fighter training class with an aside comment addressed to Maverick by another pilot, Slider, who is part of another team competing against Maverick's team. One of the instructor's challenges, “What were you thinking up there?” Maverick responded with the above quote. Even though Maverick successfully defeated his opponent, he did so by ignoring a preferred, textbook maneuver that would have caused him to retreat. As represented in this movie, the above lines represent the inability to think faster than instincts in a fast moving dogfight among jet planes, and the potential respect to be gained from a competitor by the attempt to be successful in spite of contravening conventional thought. With this entire portion of the movie script, the instructor could take the perspective of connecting the activities of audience members with respect to their interactions with clients to an encounter among fighter planes. With respect to the above lines, the instructor could connect the responses of the audience in an encounter with a client as necessitating an instinctive quality more than a thinking one since they may not have quick access to training and support materials to help them. As an example of another point that could be made from the above lines, the instructor could connect the client or others to the competing pilot team containing Slider while connecting the audience to Maverick. The perspective an instructor could take with this connection is that of securing the respect or admiration of clients or others through success that may be wrong according to established norms. The point of these lines would be to encourage the audience to rely upon their instincts and to defy convention when pre-established thoughts or conventions cannot prevail or are inaccessible; making interpersonal relationships stronger are more important than being able to show adherence to established relational guidelines.

Another representative movie is Braveheart. The particular line, “men don't follow titles, they follow courage,” is a key line in the movie. With respect to this line, it is associated with the character “William.” As represented by the script, the Scottish noble, Robert the Bruce, is attempting to speak to the rebel leader, William Wallace, after an exchange between William and the Scottish nobles' council. Robert seeks to convince William of the need for the other nobles help and encourages patience and compromise on William's part. William reminds Robert that men are not necessarily following men with titles in their struggle to overthrow English rule but rather they tend to follow those with courage. With this portion of the movie script and the above line, the instructor could take the perspective of placing the conversation within a business realm by connecting Robert to the audience and having William's words directed to them in a business sense. The point the instructor could make around this is that the courage to do what is right for others is more likely to influence the growth of strong interpersonal relationships than the reliance upon superficial attributes such as titles and credentials to do the influencing.

Another representative movie is Rocky. As represented by the movie's plot, an amateur boxer works hard to defeat the reigning champion against whom he has been offered an opportunity to fight. Despite losing the fight, his efforts and endurance took on heroic proportions; even in defeat he achieved a heroic victory. With this movie's heroic aspects, the instructor could take the perspective of connecting the audience to the amateur fighter and winning to the champion. The point the instructor could make around this is that audience members have the potential to gain something even if the more tangible aspects such as securing a sale are not forthcoming. A potential question to the audience that could help crystallize this point could be, “What is the difference between a victor and a hero?” with the answer being that a victor must win to exist.

It is to be understood that the songs and movies related above are only a representative sample of songs and movies that the present invention could utilize to serve as illustrations to derive a particular point and are not intended to limit the invention in any manner. The particular use of these songs and movies could be modified as necessary as determined by the judgment of the instructor. For example, these songs and movies could appear with any particular allegory or separately. Furthermore, the presentation of the song or movie by the instructor could give more time to certain aspects depending upon the needs, questions, and comments from the audience. A particular point may need to be emphasized more with a particular audience. It is also to be understood that the presentation of the song or movie may include questions or comments from the audience. It is also to be understood that these songs or movies can be in any format chosen using sound judgment.

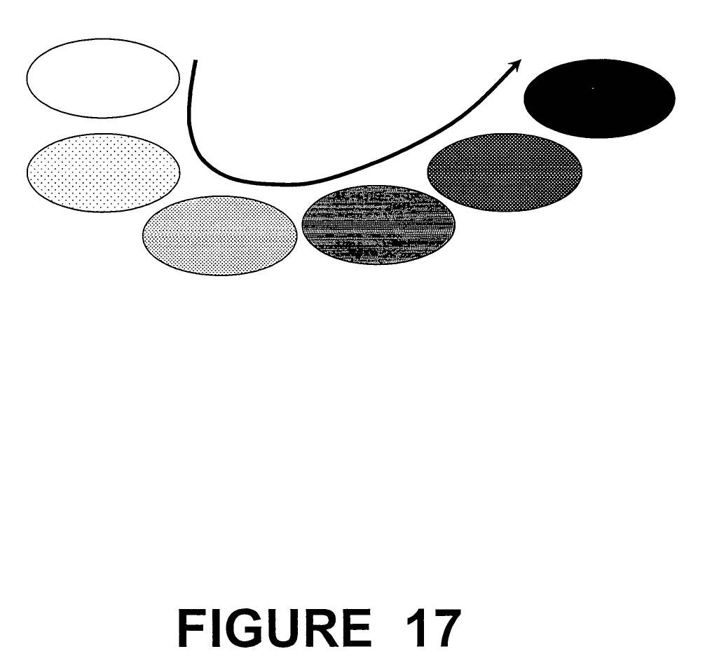

With reference now to FIGS. 17-21, another example of an allegory to use is shown as a series of diagrams

FIG. 17 shows a progression from a completely white oval to a completely black oval. In this example, FIG. 17 represents taking a blank oval and randomly highlighting every point on the oval in black. Eventually the oval would be completely black; the black, curved arrow represents the transitional journey from a white oval to a black one through the aforementioned highlighting process. Obviously, the white oval contains many points which could be highlighted but none are. By highlighting every point in the oval, the oval will change from all white to all black. The white oval represents the perspective of no focus on anything, whereas the black oval represents the perspective of focus on everything. Whether the oval is seen as all white or all black does not matter from the standpoint of understanding what makes up the oval. As an analogy, there is a forest representing the oval and trees representing the points in the oval. Whether all the trees are not seen or all looked upon at once, there is still only a forest. As a further enhancement of this analogy, there is a person looking down high above from a plane upon a forest. While that person most likely will not be able to see individual trees, he will most likely be able to tell there is a forest. This event represents looking at a white oval. With the same person looking from above at a nearer level where he can see individual trees, he will see all the trees at once. This event represents the black oval. Whether or not this person can see individual trees, his focus is still the forest. Likewise, whether no points are seen or all are seen at once, there is only an oval. Continuing with the analogy, the person is removed from the plane and placed in the forest next to a tree. He no longer has the advantage of seeing the entire forest, but now he can begin to examine a tree that comprises the forest which he could not do from the plane. By understanding a tree and its interrelationship with other vegetation, the person in the plane will come to understand the forest better. Likewise with an oval, understanding it begins with looking at a single point and its interrelationship with other points. The instructor will use this diagram to make the point that there are differences between the abstract and the practical. In order to enter into a discussion about anything new, it is better to follow a natural growth cycle entailing movement from the small to the large, from the one to many, from inside to outside. This means beginning to explain the larger abstract concept represented by the oval by starting with the smaller practical task of looking at a single aspect of the concept represented by a single point in the oval.

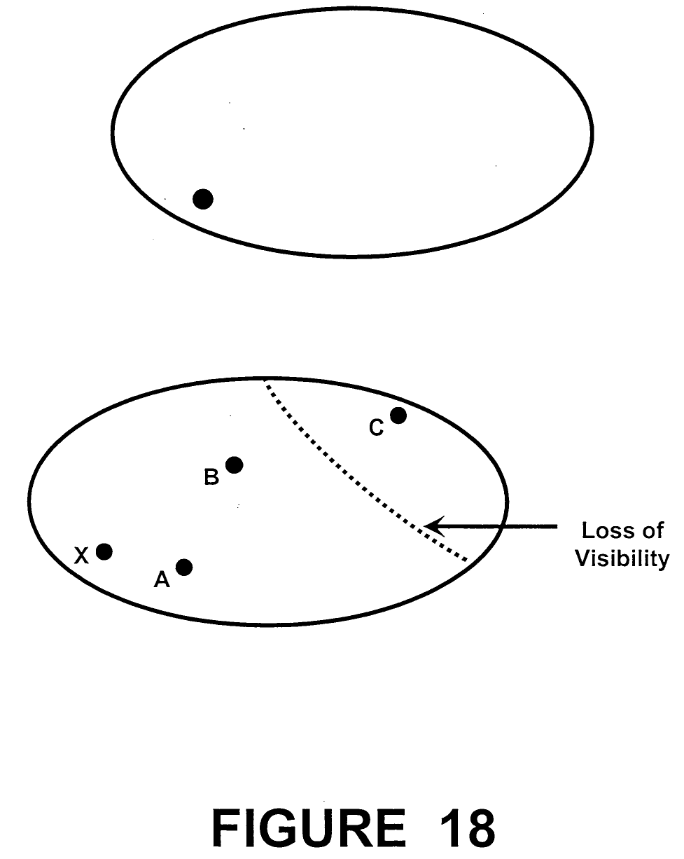

With reference now to FIG. 18, the initial selection of a point is illustrated by highlighting a single point in the oval as shown in the top oval. The selection of the point represents a certain viewpoint. With this point, there is now a frame of reference by which to address other points. For example, a determination of which points are farther away than others can be made. With reference now to the lower oval in FIG. 18, this first point selected in the upper oval is labeled “X”. Three additional points are selected as illustrated in the lower oval of FIG. 18 and labeled “A,” “B,” and “C”. At a certain distance a point becomes too far away to be seen. This is illustrated in FIG. 18 by the line labeled “Loss of Visibility.” With these illustrations, the instructor could begin to associate them to a business event. For example, in a business meeting, “X” would be the meeting's starting point and each of the other points would represent a discussion point as follows: “A” is very relevant, “B” has little relevancy, and “C” is not even considered initially. The oval would then represent all that could be addressed in this meeting about the topic without time limitations. As can be seen from the illustration, relevance is subjective based upon perspective assumed, in this case point “X”. For example, setting expectations as represented by the initial point “X” strongly affects the outcome of a process based upon that perspective because the other points “A”, “B”, and “C” are explained in terms of that perspective. The point is to show how focus on a particular point suddenly creates a perspective from which we can discuss “A,” “B.,” and “C.” If the instructor deemed it important, this same symbolism could be used to illustrate discrepancies of opinion about the same topic. For example, the instructor could assign point “X” as the initial perspective for one person and point “C” as the initial perspective for a second person. By encouraging the audience to discuss how “X” and “C” would view the other points including each other, the instructor would have a tool by which to symbolically show how different perspectives conflict and the need to try to arrive at a mutual perspective or the ability to look at the same topic from a different perspective.

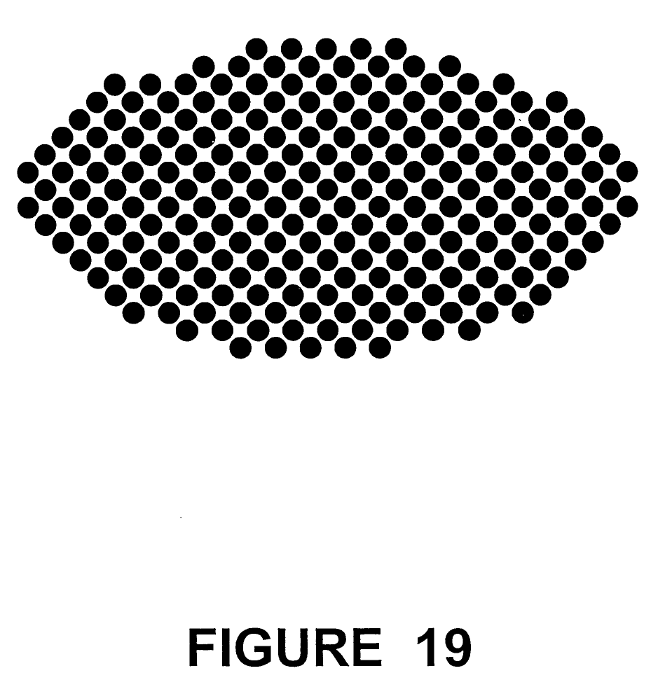

With reference to FIG. 19, the outcome of a continued exploration of other points within the oval is shown. The process of exploring other points could lead beyond “A”, “B”, and “C” to include others such as “D”, “E”, “F” and so on to create a larger collection of points belonging to the oval originally shown in FIGS. 17 and 18. By removing the boundary associated with the oval as shown in FIGS. 17 and 18, the symbolism of not knowing ahead of time what conclusion should be drawn from this exploratory process can be established. For example, in a fact gathering process a conclusion is often drawn once sufficient facts have been gathered. The conclusion ahead of this process may or may not be obvious. Connecting this to FIG. 19 the purpose of the aforementioned exploratory process is to determine what shape is present. As the process collects more dots they begin to look like an oval as illustrated in FIG. 19. In fact, if enough points are included it will look similar to one of the ovals in FIG. 17, if the boundary line is removed. The point could raise discussion about whether this collection of points is an oval or just looks like an oval with the purpose of illustrating the difference between not having all the facts and having enough facts to make a conclusion about the shape. One perspective may say, “I am not sure we have an oval, because we need more data points in order to make sure we have an oval.” Another perspective may say, “Anyone can see that that is an oval. We do not need to collect additional data.” Another likely point that could be made by the instructor regarding the first perspective is that by the time a quantifiable measurement proves it is an oval, most people would have already believed, or felt, that it was an oval. By implication, if a particular problem required an oval, the solution would be delayed by needing explicit proof of having an oval. Since life is ever changing, seeking quantification may cause failure to use the oval at the most opportune time. Additionally, a third likely point is that the degree to which proof of an oval is needed will depend again on perspectives as illustrated in FIG. 18.

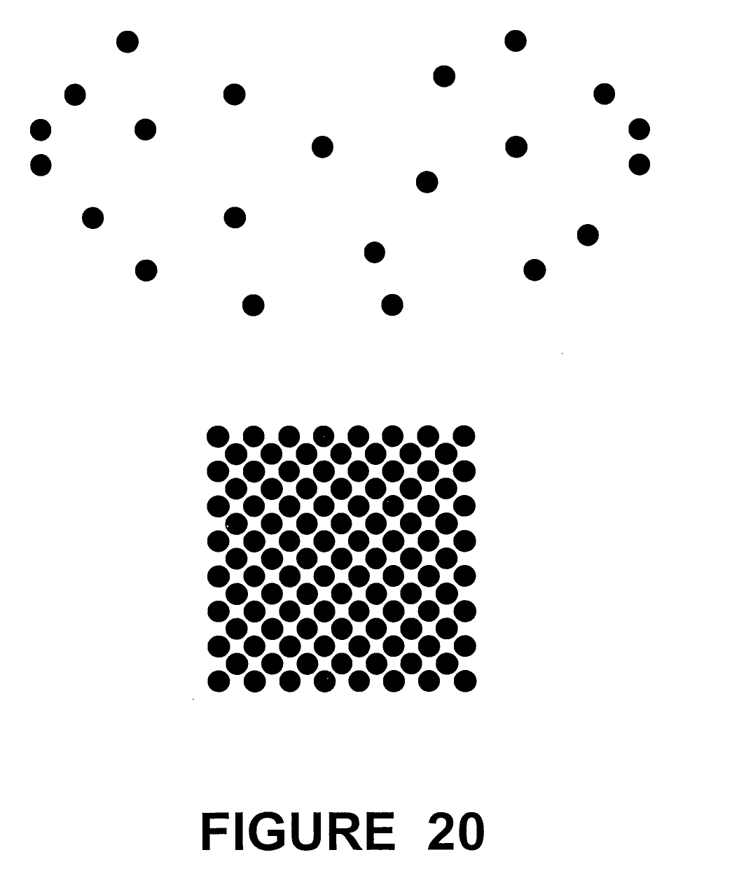

With reference now to FIG. 20, two different diagrams are shown that were both derived from FIG. 19 by removing certain points and leaving the others in their original locations. The top diagram contains twenty-five remaining points where most of the points are no longer adjacent to other points. The bottom diagram contains one hundred thirteen points where all remain adjacent to at least some of the other points. The remaining points in the top diagram abstractly represent an oval shape, and the remaining points in the bottom diagram abstractly represent a square shape. With reference to the clarity of these shapes, the adjacency and density of the points in the bottom diagram more clearly represent a square than the points in the top diagram represent an oval. The point of these two diagrams is to show that while the bottom diagram kept over five times the number of points from FIG. 19 than the top diagram kept, the top diagram looks more like an oval than the bottom diagram; keeping more points does not necessarily mean a better representation of the original oval. This introduces a qualitative aspect to the points that remain. The instructor could also relate this point back to FIG. 18 by illustrating the importance of perspective in determining the qualitative aspect; the decision as to what points are good to keep in order to still have an oval is dependent upon which other points are kept. No one point is good or bad except in terms of how it relates to the others so that they continue to represent an oval. The selection of the first point gives a perspective by which to determine which other points would be good to preserve the resemblance to an oval.

With continuing reference to FIG. 20, the instructor would take these symbols and relate them to various business situations. For example, the instructor would connect the oval to a problem and the points to facts that would indicate a potential solution. From here the instructor could distinguish a qualitative difference in facts to show how possessing the most facts does not necessarily derive the best solution. The top diagram would represent a careful screening and selection of facts to generate a good solution that would be represented by the points resembling an oval. The bottom diagram would represent a situation whereby the collection of more facts would generate a less desirable solution as represented by the points resembling a square. The instructor could also add the condition that when a solution is sought, there is often no pre-existing knowledge of whether an oval or square is the ideal solution. In this case, the instructor could demonstrate that the researcher deriving the points in the bottom diagram would not know whether he was looking for an oval or a square. His assumption would be that the square is the solution to the problem. Likewise, a researcher deriving the top diagram would be in the same position. The point the instructor can make by adding this condition is that the outcome to researching a problem is often dependent upon the perspective the researcher has on how to approach a particular problem. In this way, the instructor could make the point of linking the matter of perspective to the matter of approach; the manner in which someone approaches a situation will most likely influence the outcome.

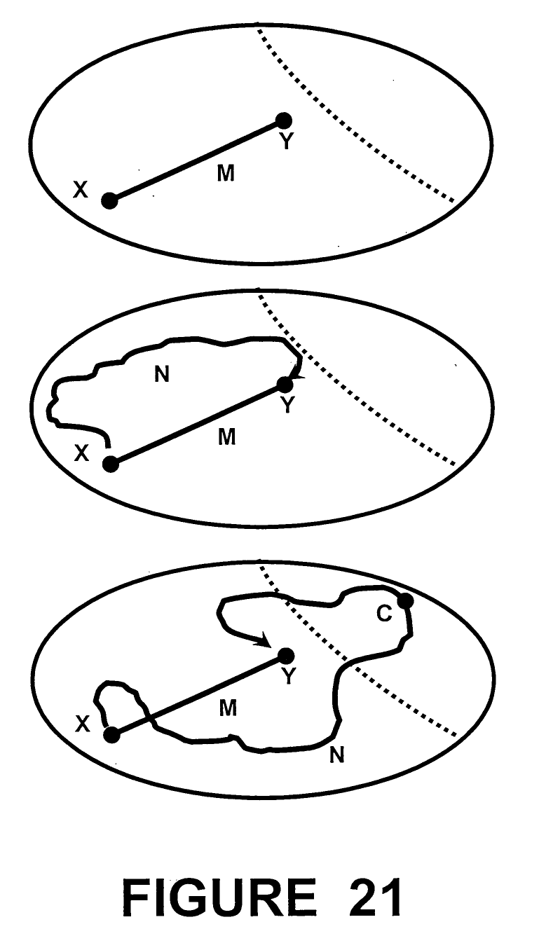

With reference now to FIG. 21, starting in the top diagram with the same point X from FIG. 18 and extending a straight line M from this point, a second point Y is derived by the end of the straight line M. Point X represents an origination point, point Y represents the termination point, and M represents the most direct route between the two points. The dotted curved line continues to represent the “Loss of Visibility” originally established in FIG. 18. With reference to the middle diagram, starting with point X and drawing a curvy arrow N until it reaches point Y, an indirect route is derived. With reference to the bottom diagram, point C represents a point outside the visibility of point X. Continuing with the bottom diagram, starting at point X and drawing a curvy arrow that goes through point C and terminates at point Y, another indirect route N is derived. As with FIG. 18, the oval in FIG. 21 continues to represent the extent of the subject of which points X, Y, and C and lines M and N are a part. The three diagrams in FIG. 21 serve to connect the various points in FIGS. 17-20.

With continuing reference to FIG. 21, the top diagram relates to FIG. 18 with respect to the initial selection of a point to establish a perspective. This is point X. In the same way point X establishes a perspective, line M does too; that perspective is one of determining which route is the most direct route between points X and Y. The perspective of the most direct route is derived once a second point Y is selected. As shown in the middle diagram of FIG. 21, with this perspective M, the nature of an indirect route as represented by the curvy arrow N can be determined relative to the direct route represented by line M. This represents the problem of not knowing if a route is indirect until the direct route is known and relates back to FIG. 17 by the necessity for a starting point to explore the oval.

With continuing reference to FIG. 21, the bottom diagram in FIG. 21 relates to FIGS. 19 and 20 because the curvy arrow N and the point C represent the experiencing of something not originally visible from point X. Line M in FIG. 21 represents clarity through directness and relates to the clarity shown by the bottom diagram from FIG. 20. This can be expressed as “the bottom diagram in FIG. 20 more directly relates to being a square than the top diagram in FIG. 20 relates to being an oval.” The bottom diagram in FIG. 20 can also represent the collection of information directly related to one another as illustrated by the adjacency of the points in the bottom diagram. Continuing with FIG. 20, the top diagram illustrates the collection of points indirectly related to one another as represented by their general lack of adjacency to one another.

With continuing reference to FIG. 21, the bottom diagram with respect to line M and arrow N represents the indirect route N discovering something that the direct route M would have missed. As an analogy, a military force that is reconnoitering seeks to disperse some of its elements to collect information; it does not seek to consolidate itself in its camp or headquarters. The top diagram in FIG. 20 represents a reconnoitering force through its dispersion relative to the bottom diagram in FIG. 20. Relating this to the bottom diagram in FIG. 21, the indirect route N is more appropriate for a reconnoitering force because points such as C and not directly related to line M come into play to provide the reconnoitering force a better picture of the entire oval.

With further reference to FIG. 21, an instructor could connect these to business by using a meeting between an employee and a customer where, as an example, X would be the beginning point, Y the objective, and M the steps going from X to Y entailed in an agenda. The top diagram of FIG. 21 identifies a perspective through a beginning point X, a direction M, and an objective Y. The middle diagram defines the indirect approach with line N. N could represent how the meeting actually progresses as opposed to how it was planned in the agenda. This allows the audience to see the determination of what is expected versus what is unexpected and helps identify ways to surprise someone. Often, the phrase “exceeding a client's expectations” is really only one-dimensional thinking. Taking a different path or direction to arrive at the same place is a differentiator especially if no one has traveled that path before. People often assume the quickest way is the best way, especially when it comes to helping clients. This assumption implies that adding value in any other way besides efficiency will not translate into higher fee revenue; thus, the only way to add value is to do things quicker and not better. The main point of the diagrams in FIGS. 17-21 is to show the interrelationship between the abstract and practical viewpoints through the establishment of a perspective and the use of an indirect approach.

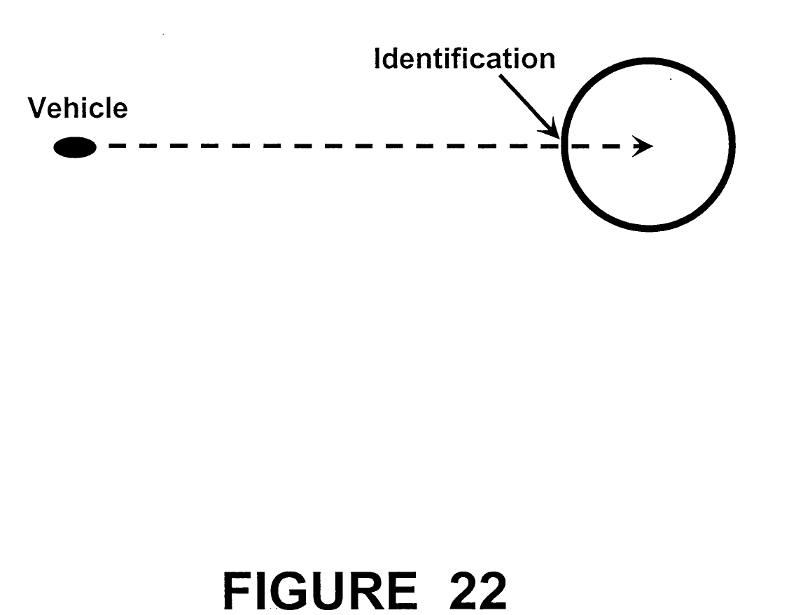

With reference to FIGS. 22-33, another example of an allegory to use is shown as a series of diagrams. FIG. 22 shows a black oval labeled “vehicle,” a black, outlined circle, a hashed arrow running from the vehicle to the center of the circle, and another solid arrow pointing to the intersection of the arrow and circle with the label of “identification.” This diagram is initiating an analogy whereby the oval represents an unidentified vehicle whose lights are on and approaching from the horizon along a straight road along the route indicated by the hashed arrow. The center of the circle represents the location of an observer, and the line illustrating the circle itself represents the range from the observer at which he is able to identify what kind of vehicle is approaching. The solid arrow indicates the point along the vehicle's path at which the observer is able to identify the vehicle. This diagram shows the point that, irrespective of the observer's identification of the vehicle, that vehicle is approaching as represented by the hashed arrow between the vehicle and the point of identification. From a business perspective, the instructor could suggest to the audience that this diagram symbolizes that events are going on around them irrespective of their ability to identify them. The point of this diagram is to begin to show the independence of an event from its identification.

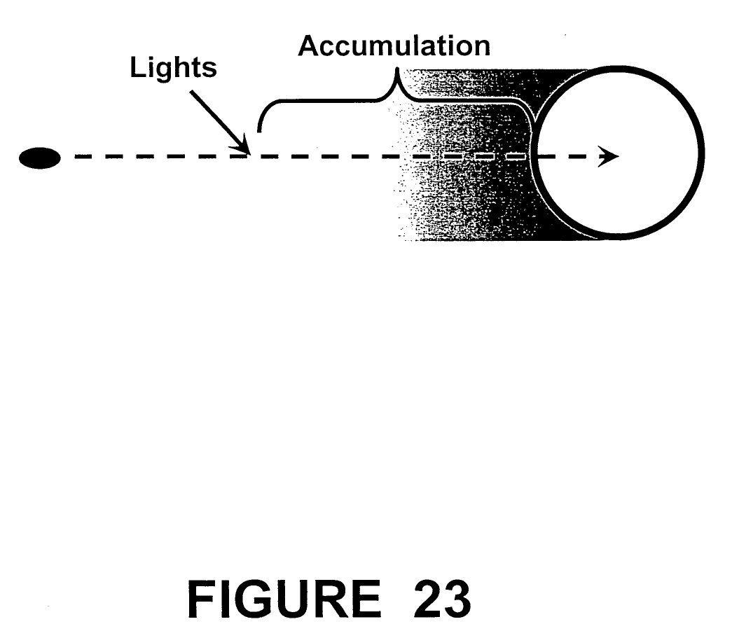

With reference to FIG. 23, two other aspects are labeled. The first is a point along the hashed arrow indicated by a solid arrow labeled “lights.” The second is a gradient beginning at the solid arrow and ending at the circle labeled “accumulation.” The indication of lights represents the point at which the observer first sees the vehicle's headlights. The gradient labeled “accumulation” represents the accumulation of facts as the vehicle approaches that allows the observer to identify the vehicle. Again, this identification is represented as the intersection of the circle with the hashed arrow. The left end of the brace further represents when the observer sees the vehicle's headlights, and the right end of the brace further represents the observer's identification of the vehicle. The gradient moving from light to dark, from left to right, represents the gradual nature of the accumulation of facts about the vehicle by the observer. The lighter the gradient the fewer the facts accumulated by the observer. This diagram shows that regardless of the observer's awareness that a vehicle is approaching, the vehicle is approaching. It also seeks to show that the observer's identification of the vehicle can be a gradual one from the point of awareness. The distinction between awareness and identification becomes symbolic through the use of this diagram. The point of this diagram is to introduce other elements beyond identification, such as awareness, from which an event is independent. The instructor could make a business connection by indicating that simply because someone may not be aware of, or able to identify, an event does not necessarily mean the event is not occurring.

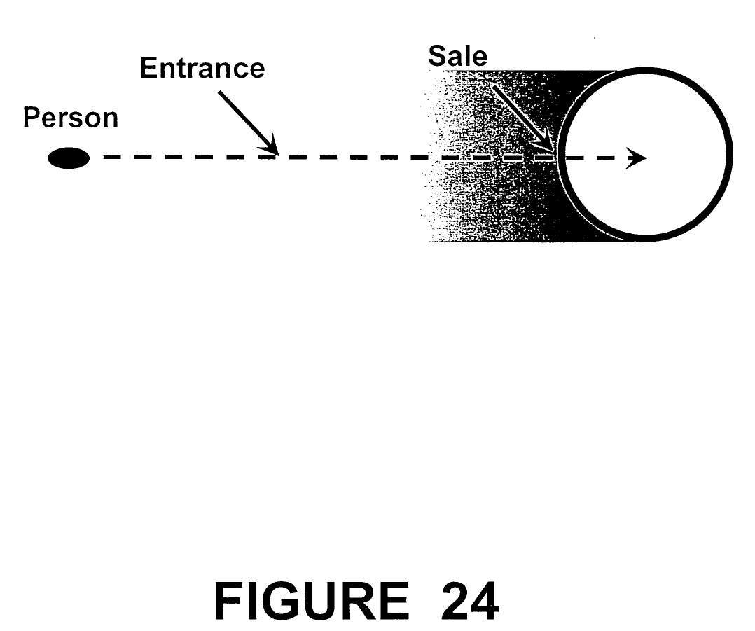

With reference to FIG. 24, there is a change to the labeling of the diagram. The “vehicle” becomes a “person, “lights” become “entrance,” and the original identification point in FIG. 22 becomes “sale.” The center of the circle remains an observer with the circle as the observer's ability to register a sale. The diagram now represents the act of a person buying something by entering a store at which the observer works. The hashed arrow represents the journey of the person to the store and the buying of something in that store constituting a sale. The gradient now represents the observer's increasing awareness that a sale will occur with the moving from light to dark indicating a greater likelihood for a sale. The area on the hashed arrow between the person and entrance into the store represents the person's travel to the store. The diagram shows that irrespective of an observer's awareness of the person entering the store or of recording the sale, the person was moving toward a purchase. Furthermore, the diagram shows that independent of when the observer was able to record the sale, there was a period of activity leading up to that sale. The diagram segregates the counting of a sale from the activities that need to take place for that sale to occur. The point is that the business derived today is the result of the much earlier initiation and interrelating of activities. There is a time lag between the identification of an event and the initiation of activities encouraging it to happen.

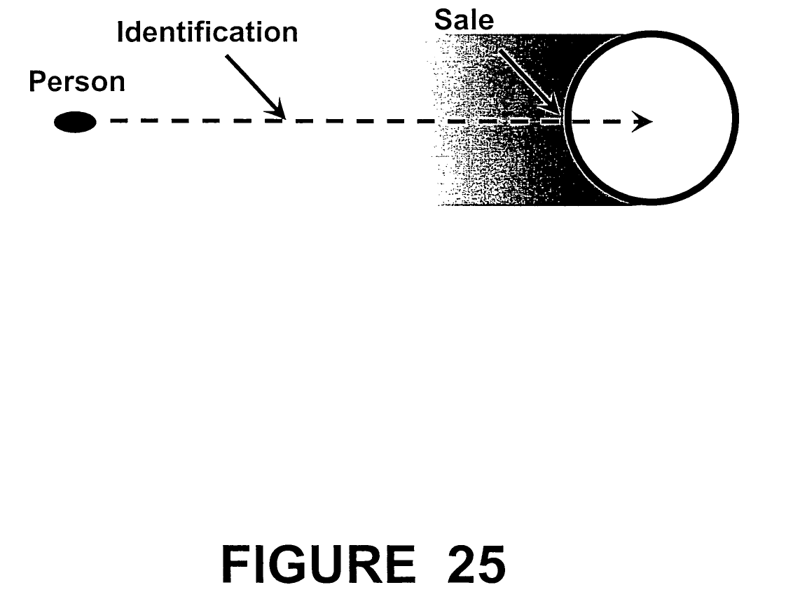

With reference to FIG. 25, the diagram remains the same as FIG. 24 except “entrance” is change to “identification.” The diagram now represents the more general act of someone buying something whereby “identification” represents the observer's awareness that this person is interesting in buying something he has to offer, the observer represents a salesperson, “sale” represents when the observer consummates the sale of something, and the gradient represents the accumulation of facts that lead the observer to increasingly conclude that a sale will be made. The diagram shows that irrespective of the observer's awareness of this fact, the person already has an interest as represented by the portion of the hashed arrow between the person and the identification arrow. Furthermore, the diagram shows that independent of when the observer sold something to the person as represented by the “sale” arrow, there was a period of activity leading up to that sale. Some of this activity occurred outside the observer's awareness while some occurred within as demonstrated by the gradient. The diagram segregates the actual sale from the activities that need to take place for that sale to occur. The point is similar to FIG. 24 in that the business derived today is the result of the much earlier initiation and interrelating of activities; there is a time lag between the identification of an event and the initiation of activities encouraging it to happen. However, the elaboration of this point as shown in FIG. 25 expands the scope of the discussion.

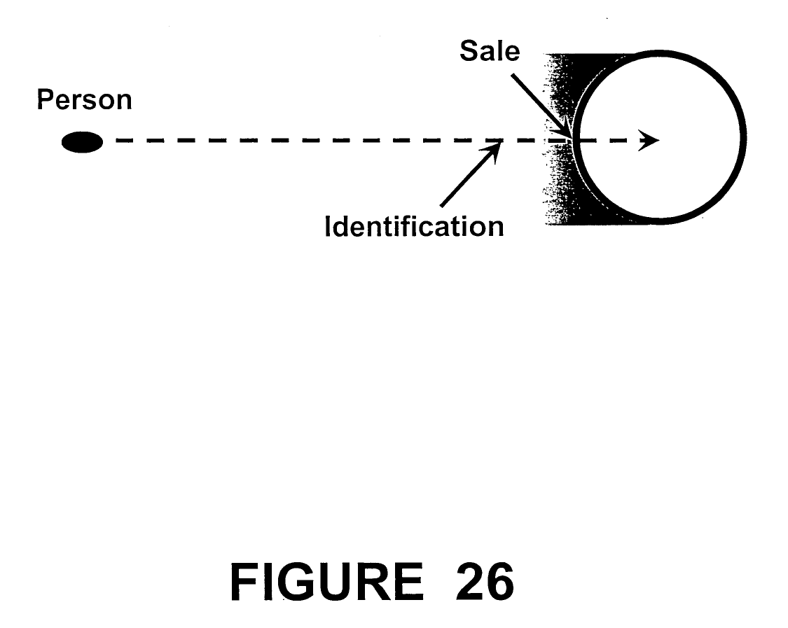

With reference to FIG. 26, the diagram remains the same as FIG. 25 except the gradient is shortened. The diagram still represents the more general act of someone buying something, but the shortened gradient represents the variance in length of the various aspects of the general act of selling relative to one another. The distance between “identification” and “sale” now represents a much shorter time period in which the observer builds awareness to the fact that a sale will occur. The distance between “person” and “identification” now represents a longer period in which the observer is unaware of actions by the person that contribute to the entire event. The diagram continues to show that irrespective of the observer's awareness of a sale, the person is taking action to purchase something. But, the additional element shown here is the timeframe under which those actions occur could be much longer and more involved than those of which the observer is aware. The point is to show that the actual points of “identification” and “sale” can vary by the particular characteristics of the entire event. For example, an online transaction over the Internet may have the person doing much investigation of a product or service before purchasing it. Nevertheless, the company providing that product may not be aware of those actions by the person. Yet, when the person finally accesses the website to purchase the product, the time between when the company is aware of the person being on its website and the actual purchase of the product may be extremely short.

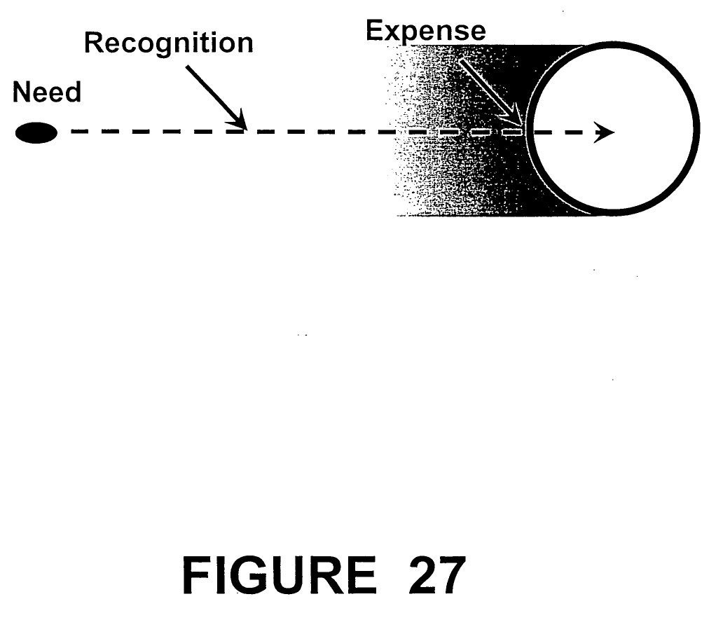

With reference to FIG. 27, structurally there is a return to the diagram in FIG. 25 with changes to its labeling as follows: “vehicle” becomes “need,” “identification” becomes “recognition,” and “sale” becomes “expense.” The center of the circle remains an observer with the circle as the observer's ability to incur an expense. The diagram now represents the act of a person incurring an expense for something he needs. The hashed arrow represents the journey of the need toward realization as an expense. The gradient now represents the observer's increasing awareness as to the nature of the expense that will take such forms as the ability to determine for what the expense will be and for how much. The area on the hashed arrow between the need and recognition represents the period of unawareness by the observer for the need. For example, an owner of a factory may not be aware of a machine in need of repair because of a worn out part until it breaks. Nevertheless, the part is wearing out despite the owner's awareness of it. If the owner was aware of it before it broke, he could possibly have saved himself some down time by ordering the replacement part and repairing the machine ahead of time before the part broke. The diagram shows that irrespective of an observer's awareness of a need for an expense that need is still approaching in the sense that an expenditure to cover it will become increasingly more likely or more urgent. Furthermore, the diagram shows that independent of when the observer incurred the expense, there was a period of activity on his part leading up to that in which the actual expense became more apparent. The diagram segregates the incurrence of an expense from the activities prior to it. The point is to show another aspect of business that is the result of the much earlier initiation and interrelating of activities where some are recognized and some are not but this recognition is independent of the activities actual occurrences.

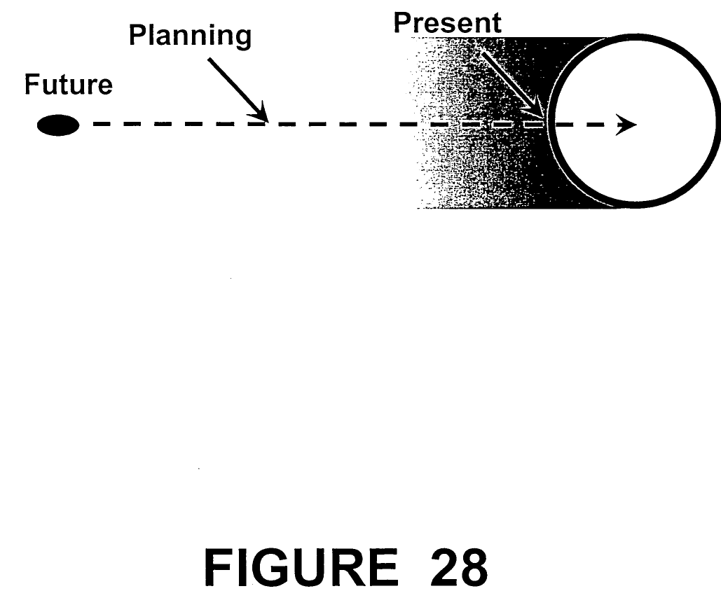

With reference to FIG. 28, the diagram remains the same as FIG. 27 except with changes to its labeling as follows: “need” becomes “future,” “recognition” becomes “planning,” and “expense” becomes “present.” The center of the circle remains an observer with the circle as the observer's actions in the present. The diagram now represents the observer's actions toward a future event. The hashed arrow represents the approach of some time in the future towards its realization in the present. The gradient now represents the observer's increasing awareness as to the nature of that future event and to the actions he may need to take to address it. The area on the hashed arrow between the future and planning represents the period of unawareness by the observer for that future event. The diagram shows that irrespective of an observer's awareness of a future event, it is still approaching in the sense that conditions around which it depends will continue to evolve. Furthermore, the diagram shows that independent of when the observer becomes enmeshed with the event in the present, there is planning that is formally expressed as a document or informally expressed as anticipation occurring as conditions and other factors surrounding the event become clearer. The diagram shows the segregation of an event's occurrence in the present from all the evolving conditions and factors leading up to its occurrence. The point is to expand the symbolic comprehensiveness of the diagram by showing that the approach of a future event is independent of our awareness of and planning for the conditions and factors that may facilitate successful dealing with that event.

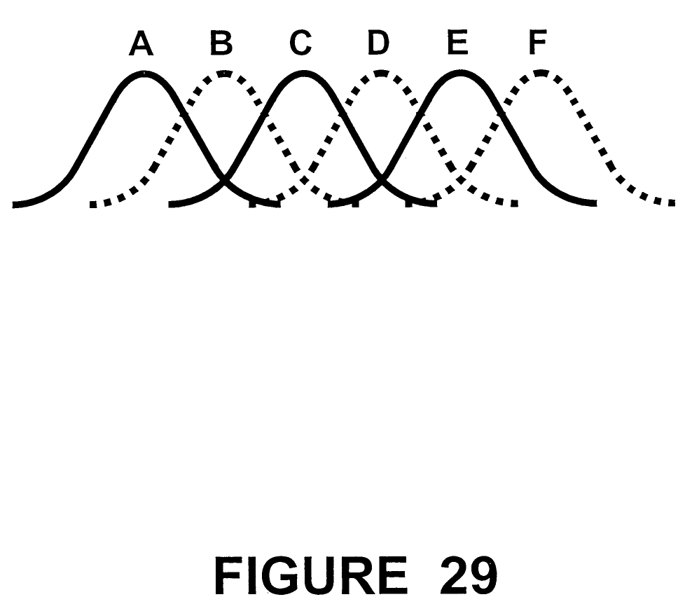

With reference to FIG. 29, six overlapping, sequential bell curves are shown horizontally across the page and alternating between a solid, black, curved line and a dotted, black curved line. The first, third, and fifth bell curves in the overlapping sequence are composed of sold, black, curved lines and the second, fourth, and sixth bell curves are composed of dotted, black, curved lines. The first bell curve is labeled “A,” the second “B,” the third “C,” the fourth “D,” the fifth “E,” and the sixth “F.” Each curve represents a separate event where B-E are the result of a previous event and a precursor to the one immediately following it. Curve A represents the event that initiates the sequence, and Curve F represents the event that culminates the sequence. The totality of the curves which is expressed as the diagram in FIG. 29 represents a sequence of interrelated events where Curve A represents the initiating event and Curve F represents the culminating event. The fact that some curves are composed of solid black lines and others are composed of dotted black lines is immaterial to the diagram for the purpose of understanding it. This distinguishable characteristic serves to allow the viewer of the diagram to more easily distinguish among the curves. The bell curve of each event represents the waxing, peaking, and waning of that particular event in terms of its intensity and influence. For example, there are two sequential events where one is the swinging of a baseball bat by a hitter at a pitched baseball and the other is the flight of the ball in the air. The initiation of the swing begins with the first movement of the hitter's arms, the waxing is the acceleration of the swing as the bat and ball meet, the peak is the actual hitting of the ball, the waning is the follow through after hitting the ball, and the conclusion is when the hitters arms and bat come to a rest. The initiation of the ball's flight begins with it being struck by the bat, the waxing is its rise into the air, the peak is its maximum height, the waning is its fall back, and the conclusion is when it hits the ground and rolls to a rest.

With continuing reference to FIG. 29, the diagram shows one type of interrelationship among events that can occur to culminate in a single event. The diagram shows a relationship where an event F may be the culmination of events A-C that are no longer taking place and may no longer be visible. The diagram also shows events D and E taking place but whose influence is waning or concluding. With respect to event F, the diagram shows that by the time F concludes and an outcome is determinable all the events A-E leading up to F are no longer taking place. As an example by returning to the aforementioned swing of a hitter striking a pitched ball, when the ball finally comes to a rest the hitter may have finished his swing and dropped his bat which may cause an observer who only saw the ball come to rest to be unable to conclude that the hitter actually is the one who caused the ball to roll by him. The point is to build awareness for the potential sequential nature of events over time, resembling a domino effect. A further point becomes that while event F may be the observable event and A-E the unobservable events, unawareness for A-E does not mean they did not occur. The unawareness of an event does not prove it did not happen or did not influence an outcome. Relating this back again to the example of the hitter, the ball, and the observer, the observer is unable to conclude whether the hitter did or did not hit the ball; however, this inability to conclude that the hitter hit the ball does not prove that he did not, and the inability to conclude he did not hit it does not prove he did.

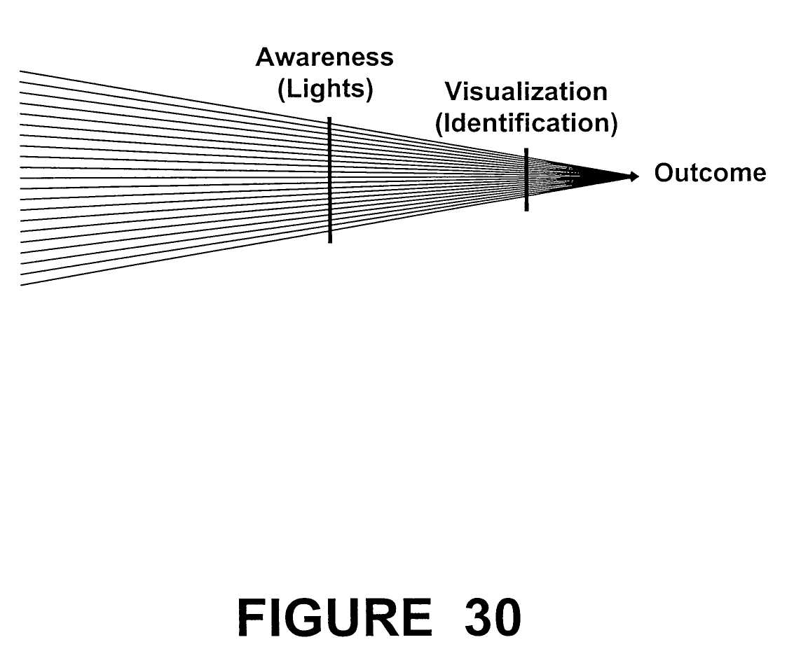

With reference to FIG. 30, many, solid, black lines converge horizontally as they move from left to right. Two black, vertical, solid lines cross the horizontal lines. The left vertical line is labeled “Awareness” with “Lights” in parenthesis underneath it, and the right vertical line is labeled “Visualization” with “Identification” in parenthesis underneath. The convergence of the lines is labeled “Outcome.” Moving from left to right represents the passage of time from future to present. Each line represents a separate event whereby collectively the lines represent many events converging to produce an outcome. The point at which the lines merge represents the outcome generated by the events and the influence of that outcome on an observer. Consequently, as the events converge to generate an outcome the point at which they converge also represents the observer. The vertical line labeled “Awareness” represents the point at which the observer becomes aware of the many events potentially influencing an outcome. The vertical line labeled “Visualization” represents the point at which the observer is able to visualize the potential event and its influence upon the outcome. This diagram shows the convergence of multiple events to yield an outcome influencing the observer. The words “Lights” and “Identification” in parenthesis show a connection between this diagram and the diagrams in FIGS. 22 and 23. The point of connecting FIG. 30 to FIGS. 22 and 23 is to overlay the symbolic connection of a single event and a single vehicle's approach onto the diagram in FIG. 30 in order to create a symbolic connection between many events and many vehicles converging. This will serve to symbolize the main point of the diagram in FIG. 30 which is that many events can influence an outcome.

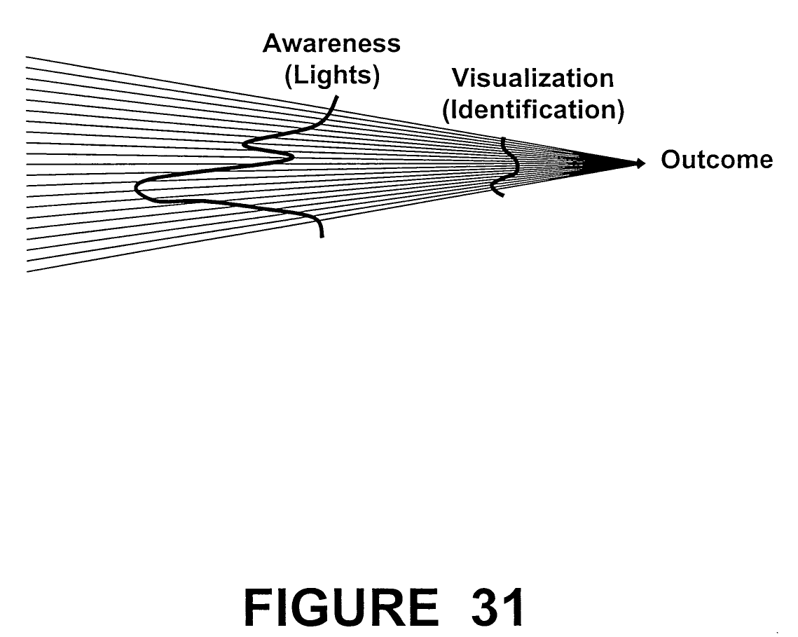

With reference to FIG. 31, the diagram remains the same as FIG. 30 except for the replacement of vertical lines with solid, serpentine lines. These serpentine lines continue to represent awareness and visualization. The diagram now shows that the awareness and visualization for each event does not happen at the same time. The point is that events can reach awareness and visualizations at different times as they converge to create an outcome influencing the observer.

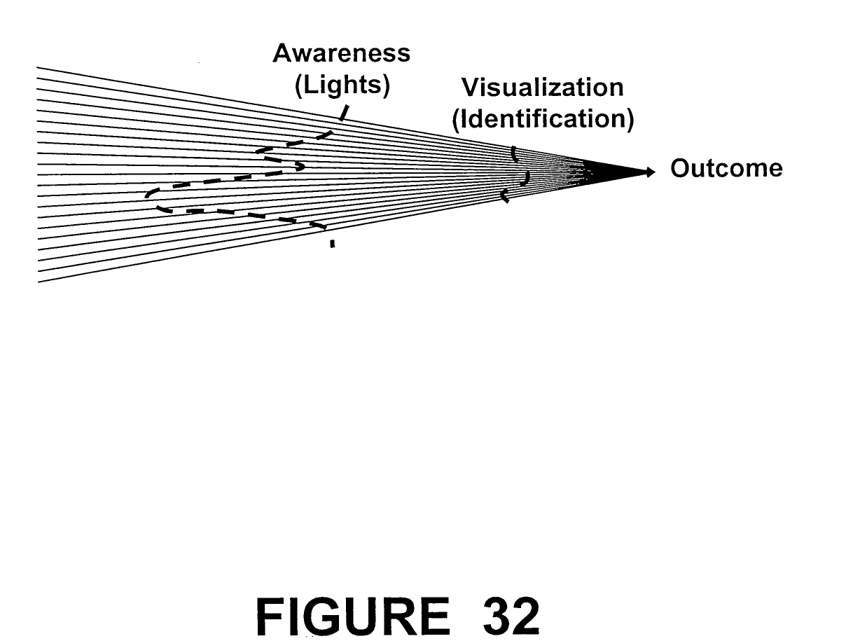

With reference to FIG. 32, the diagram remains the same as FIG. 31 except for the replacement of solid, serpentine lines with broken, serpentine lines. These broken, serpentine lines continue to represent awareness and visualization. The diagram now shows that the awareness and visualization does not happen for all events. The point is that not all events may reach awareness or visualization and will remain unknown or in various states of incompleteness to the observer.

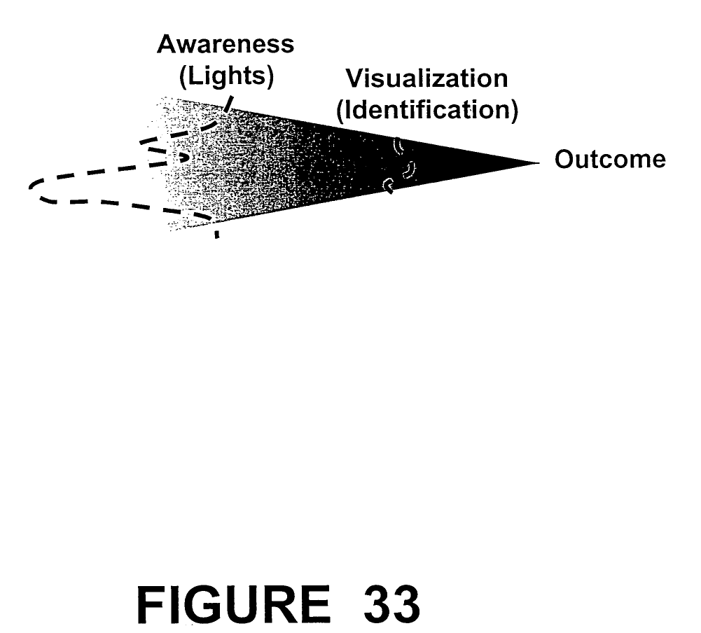

With reference to FIG. 33, the diagram remains the same as FIG. 32 except for the replacement of the lines with a converging gradient moving from light to dark as it progresses from left to right. The move from light to dark represents the gradual accumulation of observations that increase awareness and visualization. The gradient represents the blending of many events converging upon an outcome in a manner that incorporates the sequential, related nature of events in FIG. 29 with the simultaneous, distinct nature of events in FIGS. 30-32. This representation is derived by transforming each straight, convergent line in FIGS. 30-32 into a wavy, convergent one where the waviness of each line takes on the characteristics of the wave-like pattern shown in FIG. 29. FIG. 33 now shows awareness and visualization as states that vary in degree and the integration of the sequential, related nature of events with their simultaneous, distinct nature. The point is to show that outcomes are the result of an intricate, continuous blend of overlapping events that mutually interrelate with one another sequentially and convergently. This point will tend to have events take on dependent and independent characteristics relative to one another that will appear to the observer in various degrees of awareness and visualization.

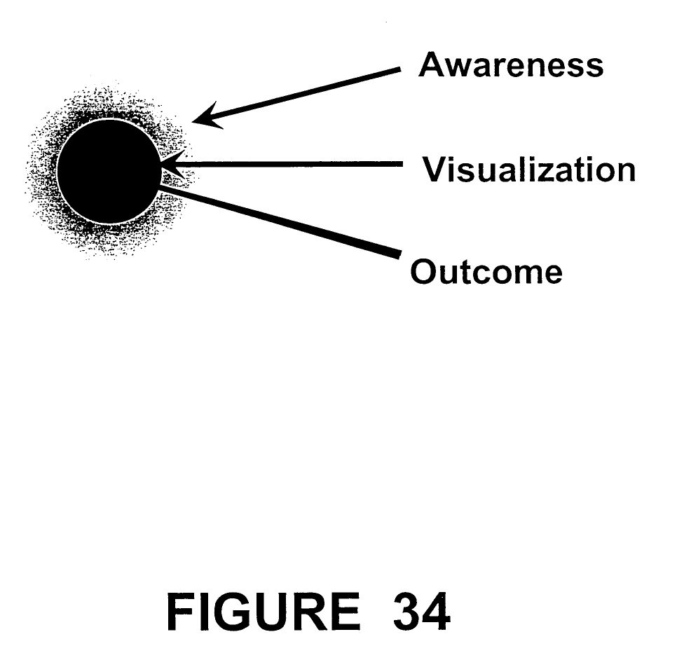

With reference to FIG. 34, there is a solid black circle surrounded by a circular gradient expanding from dark to light, from the circle outward. Three arrows point to various aspects of the diagram from a label. One arrow points to the gradient and has the label “Awareness.” A second arrow points to the outer part of the circle and has the label “Visualization.” A third and final arrow points to the center of the circle and has the label “Outcome.” The diagram represents FIG. 33 in circular form where events approach from the outside to the center as opposed to a convergence from left to right to represent a journey from future to present. The gradient represents increasing awareness of an event. The circle represents the visualization of that event. The circle's center represents the outcome of the event upon the observer. Consequently, the circle's center also represents the observer. FIG. 34 now shows the main points of FIGS. 22-33 symbolically in a circle surrounded by a circular gradient. The point is to move toward a more symbolic expression of the main points that permits a more comprehensive, holistic application. Rather than have events approach from one general direction as FIGS. 32-37 did, this diagram gives them the ability to approach from any direction.

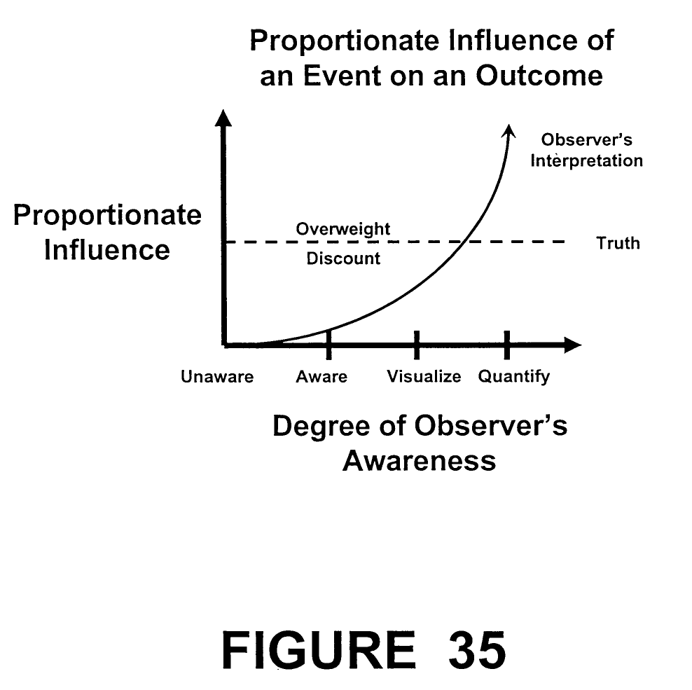

With reference to FIG. 35, a diagram takes on the appearance of a graph. The diagram's title is “Proportionate Influence of an Event.” The vertical axis is labeled “Proportionate Influence,” and the horizontal axis is labeled “Degree of Observer's Awareness.” Moving upward on the vertical axis means increasing influence. There are four labeled hash marks on the horizontal axis. Moving from left to right, the hash marks are labeled “Unaware,” “Aware,” “Visualize,” and “Quantify.” A line with an arrowhead begins at the intersection of the axis and curves increasingly upward until its head is in line with the hash mark labeled “Quantify;” and is labeled “Observer's Interpretation.” A dotted line extends straight across the graph from the middle of the vertical axis, and is labeled “Truth.” Above the dotted line is the label “Overweight”, and below the dotted line is the label “Discount.” What the diagram in FIG. 35 shows is how the proportionate influence of an event on an outcome relates to the degree of awareness of that event. The solid line shows that the interpretation of the degree to which an event influences something will increase as the awareness of that influence increases. The dotted line shows that the true influence of an event will remain the same regardless of the degree of awareness of that event. The point is that there will be a tendency to over emphasize the proportionate influence of an event, as the conclusiveness of the evidence about that influence increases. There will also be a tendency to discount the proportionate influence as the conclusiveness of the evidence about that influence diminishes. The form of evidence is more likely to impact an observer's interpretation of an event's influence than the content would. An instructor could build upon this point by asking the audience to consider various events and factors whose influence is not easily documented or quantified, but whose importance is well known. For example, if a business owner has a written brief from a consultant on the potential positive impact of a particular product on his business, the owner will tend to over emphasize the influence of that product than it has. Furthermore, if the same business owner is unaware of the employees' poor morale or only has suspicions of such lacking, the business owner is more likely to discount the influence of morale than it has. Other examples would include the difficulty of documenting and quantifying various qualitative business aspects such as product, management, and clientele.

With reference to FIG. 35, there is a solid black circle surrounded by a circular gradient expanding from dark to light, from the circle outward. Two arrows point to various aspects of the diagram from a label. One arrow points to the gradient and has the label “Intuition.” A second arrow points to the outer part of the circle and has the label “Cognition.” The diagram represents a person at any specific time relative to any events in that person's life irrespective of the influence that event has on the person. The gradient represents the person's intuitive capacities. Moving from light to dark represents increasing awareness of an event. The circle represents the person's cognitive capacities. Closeness to the center represents the degree to which the person can visualize the aspects of the event. The white area around the gradient represents a person's complete unawareness of an event. The diagram shows the status of a person's awareness of any event at a particular point in time as being in a state of complete unawareness, or in various degrees of being intuited or cognized. As an analogy, the approach of an aircraft where an observer first becomes aware of it on radar and then gains a visual sighting is similar to the same observer first receiving a feeling for an opportunity or problem and then secondly is able to define exactly what that opportunity or problem is. The point is to move toward a more symbolic expression of events relative to a person irrespective of the events' influence upon outcomes affecting that person, a symbolic expression that can serve to express how a person is aware of other people in addition to events. A further point is to establish the importance of emotions in the form of intuition as a prelude to the rationalization of those emotions in the form of cognition.

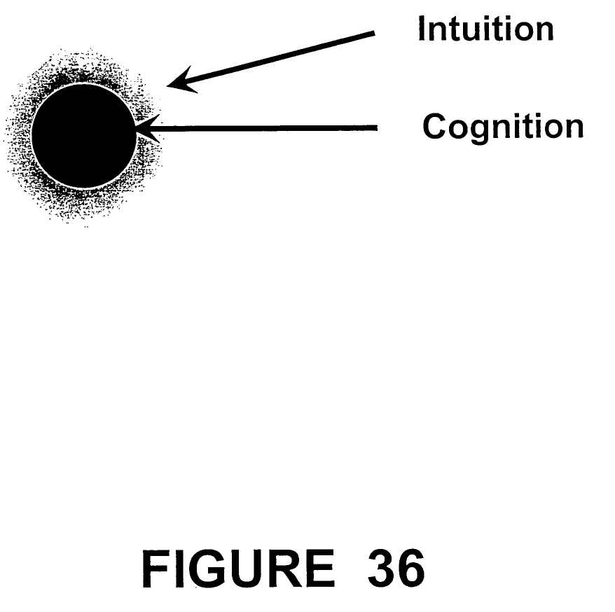

With reference to FIG. 36, there are two solid black circles of different sizes with each surrounded by a circular gradient of a different size that expands from dark to light, from the circle outward. FIG. 36 represents an elaboration of FIG. 35. The left diagram has the larger black circle surrounded by the smaller gradient. The right diagram has the smaller black circle surrounded by the larger gradient. Both gradients represent intuition, and both circles represent cognition. The white areas around the gradients represent unawareness. The left diagram represents a man, and the right one represents a woman. The diagram shows the relative cognitive and intuitive capacities in a representative man and woman. FIG. 36 shows a representative man as tending to have a greater cognitive capacity than a representative woman and shows a representative woman as tending to have a greater intuitive capacity than a representative man. For example, a woman will be more likely to perceive the potential for an opportunity or problem ahead of a man, but a once a man perceives the same potential he will be more likely to define what it actually is ahead of a woman. An instructor is likely to reinforce this symbolic expression by exploring the phrase “woman's intuition” by asking why it's not called “man's intuition.” The point is to establish a basis through which the audience can explore and explain differences among themselves and others so they can have a better understanding and appreciation for what can make their interpersonal relationships better by first having a better understanding and appreciation for the differences between genders.

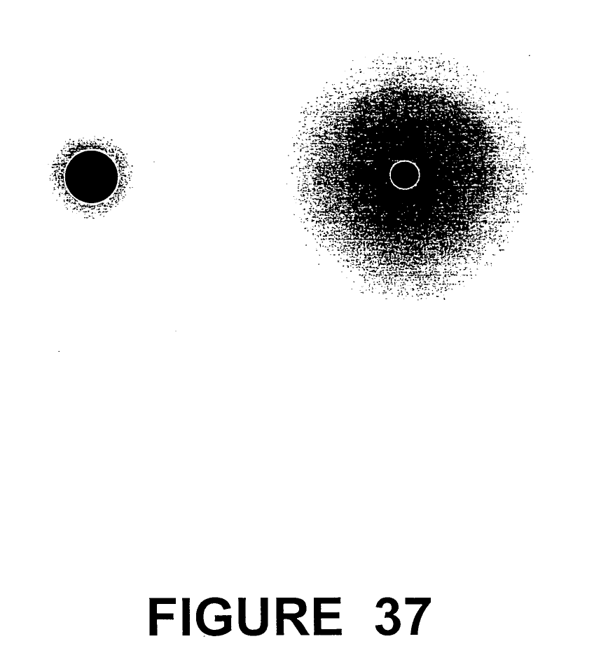

With reference to FIGS. 22-37, the instructor could make parallels to business events for which the audience may have had an instinctive feeling that caused them to explore them in more detail. The instructor could point to that first sense of something being an opportunity or a problem as examples of intuition, and to the construction of detail and information around them as examples of cognition. With FIGS. 36 and 37, the instructor could also take these same parallels about a person's awareness for events and extend them to a person's awareness of other people.

It is to be understood that the difference between the allegories in FIGS. 17-37 and the ones in FIGS. 1-16 is only an instructional one and is not intended to limit the invention in any manner. The use of these allegories could be modified as necessary depending upon the judgment of the instructor. From an instructional perspective, the instructor will most likely see the difference in these allegories as one entailing variation in depth and in arrival at a final point. For FIGS. 1-16 the instructor will most likely see a linear progression from one point to a final point with each step building upon the previous one. For FIGS. 17-37 the instructor will most likely see a presentation of several distinct lines that will converge upon a single point. As an analogy, FIGS. 17-37 would represent a wagon wheel where the spokes converge upon the hub. Each spoke represents a different line of thought with the hub being the point of the allegory at which the various lines of thought converge to support that point. As a comparable analogy, FIGS. 1-16 would represent a journey along a trail where there is an origination and termination point connected by the trail. Additionally, the instructor would most likely see a more difficult employment of instructional technique with FIGS. 17-37 as compared to FIGS. 1-16 as represented by the simple statements and questions on the allegories in FIGS. 1-16.

It is to be understood that the allegories presented in FIGS. 1-16 and in FIGS. 17-37 are merely illustrations of possible allegories that could be used in the present invention. The type and number of allegories is not limited by this invention.

The invention has been described with reference to at least one embodiment. Obviously, modifications and alterations will occur to others upon a reading and understanding of this specification. It is intended to include all such modifications and alternations in so far as they come within the scope of the appended claims or the equivalence thereof.

I/we claim:

1. A non-statistical method for training individuals to have more effective relationships, the method comprising the steps of:
providing at least two allegories, the allegories designed to make a point about interpersonal relationships;
asking a series of questions to an associated audience;
receiving answers to the series of questions;
choosing a first allegory based upon the answers to the series of questions;
relating the first allegory to the associated audience, continuing to ask questions during the relating of the first allegory;
allowing comments and questions from the audience during relating of the first allegory;
choosing at least a second allegory based upon the answers to the series of questions and the comments from the audience during the relating of the first allegory;
allowing comments and questions from the audience during the relating of the at least a second allegory;
interrelating the allegories based upon the answers, the questions, and the comments; and,
utilizing the allegories and their interrelation to progress from one idea to a final conclusion.

2. A non-statistical, empirical method for training employees to develop better interpersonal skills, the method comprising the steps of:
providing a collection of allegories, each of the allegories having a message relating to interpersonal relationships;
providing a set of assumptions;
asking a series of questions of an associated audience, the questions designed to determine the starting point of the method;
receiving answers to the series of questions;
relating assumptions to the associated audience, the amount of time spent discussing the assumptions dependent upon the answers to the series of questions;
choosing a first allegory from the collection of allegories based upon the answers to the series of questions and the set of assumptions;
relating the first allegory to the associated audience;
allowing questions from the associated audience during the relating of the first allegory;
determining the amount of time spent relating the allegory by the questions and comments from the associated audience during the relating of the first allegory;
choosing a second allegory based upon the answers to the series of questions, the comments from the audience during the relating of the first allegory, and the interrelation of the two allegories;
allowing comments and questions from the audience during the relating of the second allegory;
interrelating the allegories based upon the answers and the comments;
choosing at least a third allegory based upon the answers to the series of questions and the comments from the audience during the relating of the first and second allegories;
allowing comments from the audience during the relating of the at least a third allegory;
interrelating the allegories based upon the answers and the comments;
utilizing the allegories to progress from a first idea to at least an incrementally different second idea; and,
utilizing the allegories and their interrelation to progress from the first idea to a final idea.

3. The method of claim 2, wherein the method further comprises the step of:
utilizing the at least three allegories in progressive incremental steps.

4. The method of claim 3, wherein the method further comprises the steps of:
choosing at least a final allegory based upon the answers to the series of questions and the comments from the audience during the relating of all previous allegories;
allowing comments from the audience during the relating of the final allegory;
interrelating all of the allegories based upon the answers and the comments; and,
utilizing all of the allegories and their interrelation to progress from one idea to the final idea, wherein the difference between the point of the final allegory and the point of the first allegory is larger than the difference between the point of the first allegory and the point of the second allegory.

5. The method of claim 4, wherein the method further comprises the step of:
selecting a final idea to be reached prior to selecting the first allegory.

6. The method of claim 5, wherein the allegories are presented via an electronic medium.

7. A computer readable medium containing instructions for controlling a computer system to perform a method, the method comprising:
providing a database of allegories, each of the allegories having a message relating to interpersonal relationships;
providing a set of assumptions;
asking a series of questions of an associated audience, the questions designed to determine the starting point of the method;
receiving answers to the series of questions;
relating assumptions to the associated audience, the amount of time spent discussing the assumptions dependent upon the answers to the series of questions;
choosing a first allegory from the database of allegories based upon the answers to the series of questions and the set of assumptions;
relating the first allegory to the associated audience;
allowing questions from the associated audience during the relating of the first allegory;
determining the amount of time spent relating the allegory by the questions from the associated audience during the relating of the first allegory;
choosing a second allegory based upon the answers to the series of questions, the comments from the audience during the relating of the first allegory, and the interrelation of the two allegories;
allowing comments from the audience during the relating of the second allegory;
interrelating the allegories based upon the answers and the comments;
choosing at least a third allegory based upon the answers to the series of questions and the comments from the audience during the relating of the first and second allegories;
allowing comments from the audience during the relating of the at least a third allegory;
interrelating the allegories based upon the answers and the comments;
utilizing the allegories to progress from a first idea to at least an incrementally different second idea; and,
utilizing the allegories and their interrelation to progress from the first idea to a final idea.

8. The computer readable medium of claim 7, wherein the method further comprises the step of:
utilizing the at least three allegories in progressive incremental steps.

9. The computer readable medium of claim 8, wherein the method further comprises the steps of:
choosing at least a final allegory based upon the answers to the series of questions and the comments from the audience during the relating of all previous allegories;
allowing comments from the audience during the relating of the final allegory;
interrelating all of the allegories based upon the answers and the comments; and,
utilizing all of the allegories and their interrelation to progress from one idea to the final idea, wherein the difference between the point of the final allegory and the point of the first allegory is larger than the difference between the point of the first allegory and the point of the second allegory.

10. The computer readable medium of claim 9, wherein the method further comprises the step of:
selecting a final idea to be reached prior to selecting the first allegory.

11. The computer readable medium of claim 10, wherein the allegories are presented via an electronic medium.
